(19) United States
(12) Patent Application Publication
(10) Pub. No.: US 2008/0040211 A1
(43) Pub. Date: Feb. 14, 2008

(54) Marketing System Employing Vending Machines

(76) Inventors: Jay S. Walker, Ridgefield, CT (US); Paul T. Breitenbach, Wilton, CT (US); Daniel E. Tedesco, Huntington, CT (US); Geoffrey E. Gelman, Brooklyn, NY (US); Robert C. Tedesco, Fairfield, CT (US)

Correspondence Address: WALKER DIGITAL MANAGEMENT, LLC, 2 HIGH RIDGE PARK, STAMFORD, CT, 06905, US

(21) Appl. No.: 10/581,433

(22) PCT Filed: Dec. 9, 2004
(86) PCT No.: PCT/US04/41395

§ 371 Date: May 18, 2007

Related U.S. Application Data
(60) Provisional application No. 60/527,987, filed on Dec. 9, 2003.

(51) Int. Cl. G06Q 30/00

(52) U.S. Cl. 705/14

(57) ABSTRACT

According to an embodiment, a device provides an offer, via an interface (130) at a vending machine (100), for a benefit in exchange for an email address. An email address is received via the interface (380). After receiving the email address, a promotional message (260) is transmitted to the received email address.

### BACKGROUND

In general, a vending machine has a greater chance of achieving profitability with more exposure to consumers. A vending machine operator, in deciding whether to place a vending machine in a particular location, will typically estimate the number of people who frequent that location. The vending machine operator may then decide whether or not to place the vending machine in that location based on the estimated number of people. Unfortunately, many locations do not attract significant consumers to justify placing a vending machine in that location.

### BRIEF DESCRIPTION OF THE DRAWINGS

FIG. 1 is a block diagram which illustrates an embodiment in which a controller is in communication with a plurality of vending machine and a plurality of user devices.

FIG. 2 is a block diagram which illustrates an embodiment of a controller.

FIG. 3 is a block diagram which illustrates an embodiment of a vending machine.

FIG. 4 is a schematic illustration of an embodiment of a vending machine database.

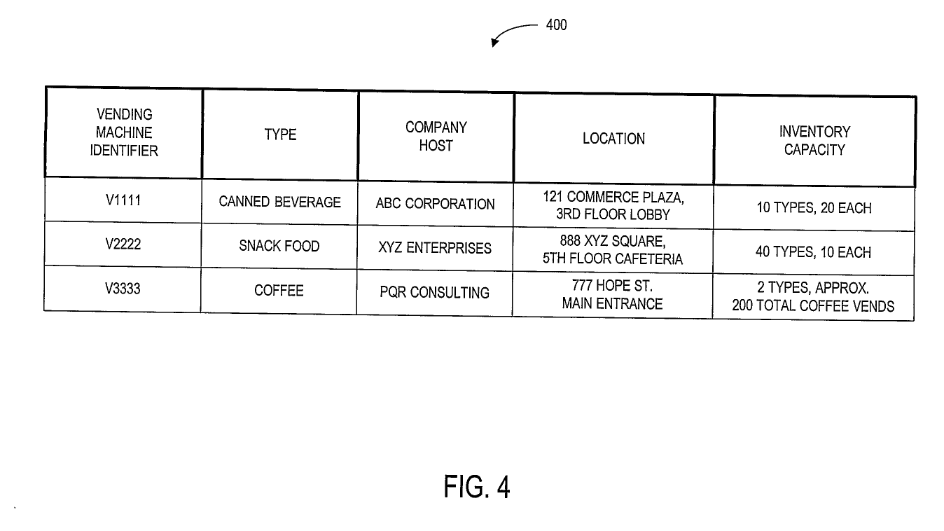

FIG. 5 is a schematic illustration of an embodiment of a user database.

FIG. 6 is a schematic illustration of an embodiment of a promotional message database.

FIG. 7 is a schematic illustration of an embodiment of a promotional code database.

FIG. 8 is a schematic illustration of an embodiment of a company database.

### DETAILED DESCRIPTION

In the following description, reference is made to the accompanying drawings that form a part hereof, and in which is shown, by way of illustration, specific embodiments in which the invention may be practiced. These embodiments are described in sufficient detail to enable those skilled in the art to practice the invention, and it is to be understood that other embodiments may be utilized and that structural, logical, software, and electrical changes may be made without departing from the scope of the present invention. The following description is, therefore, not to be taken in a limiting sense.

Headings provided herein are for convenience and are not to be taken as limiting the disclosure in any way.

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

The terms “an embodiment”, “embodiment”, “embodiments”, “the embodiment”, “the embodiments”, “an embodiment”, “some embodiments”, and “one embodiment” mean “one or more (but not all) embodiments of the present invention(s)” unless expressly specified otherwise.

The terms “including”, “comprising” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

### Definitions

The following terms are defined as indicated below, unless explicitly described otherwise:
Operator, Owner, Route Driver—The owner (or agent thereof) of a vending machine.
promotional message—a message that promotes a vending machine, e.g., by promoting sales or other activities at a vending machine, or otherwise by promoting goodwill for the vending machine. A promotional message may take the form of an email message. A promotional message may be transmitted to one or more customers or potential customers of a vending machine. A promotional message may be composed and/or sent by a controller, vending machine, or representative of a company charged with encouraging sales at a vending machine. A promotional message may indicate, for example, the existence of items on sale, a discount to be offered to a recipient, the availability of a new product, and so on.
user—a person who transacts or interacts with a vending machine. For example, a user may be someone who receives a promotional message from a vending machine, visits the vending machine, enters a promotional code indicated in the message, and who accordingly receives a discounted product. The terms “user”, “customer”, “consumer”, “employee”, and “person” may all be used interchangeably herein.
user device—a device with which a user interacts and which may serve as an intermediary between a vending machine and/or controller and the user. A user device may include a personal computer, cellular phone, personal digital assistant (PDA), laptop computer, and so on. A user device may, for example, be connected to a communications network (via a wired or wireless medium), where it may receive messages from the controller or vending machine. The user may then peruse these messages via the user device, e.g., by reading the messages on a display screen of the user device.
vending machine—an electromechanical device capable of receiving consideration and providing a benefit in return. Examples of consideration include coins, bills, credit card payments, debit card payments, smart card payments, payments from a cell phone, gift certificates, and coupons. In addition, a vending machine may treat as consideration a promotional code, in return for which the vending machine may provide a benefit. A vending machine may also treat as consideration a customer identifier, such as an email address, fingerprint, or credit card account number, where the vending machine later has the ability to collect from the customer based on the identifier. The benefit provided by a vending machine may include a product or service. Products may include food, beverages, gasoline, toys, electronic downloads, entertainment (e.g., the playing of a music video), and so on. Services may include washing clothes, providing access to the Internet, providing printouts, sending transmissions via fax or email, and so on.

### 1. Overview of Example Embodiments

Varying embodiments of the present invention allow an operator of a vending machine, or a vending machine itself, to send promotional messages to potential customers. The promotional messages may encourage people to make purchases at the vending machine thereby stimulating sales. With such a result, a location with even a small potential customer base may become a sufficiently profitable location for a vending machine.

Accordingly, Applicants have also recognized many benefits from adapting a vending machine to an office environment, especially a small office environment. For example, companies that were previously considered too small for a vending machine could profitably use a vending machine according to certain disclosed embodiments. Such companies may benefit from increased employee satisfaction stemming from the availability of vended items. Vending machine operators may, in turn, benefit from a more diverse set of locations for operating vending machines. Vending machines in traditionally profitable areas may garner even greater profits with the use of promotions.

Some embodiments allow the contact information of existing or potential customers to be acquired. In some embodiments, an operator of a vending machine agrees to place a vending machine in a company facility (e.g., in a small company) provided the operator receives a list of email addresses of company employees. The vending machine operator may then use the email addresses to send promotional messages, e.g., which encourage sales at the vending machine.

In some embodiments, a vending machine may receive contact information directly. Such a vending machine may solicit contact information during a customer transaction. The vending machine may offer a benefit, such as a free beverage, in exchange for a customer entering his email address.

Some embodiments provide rules as to when and/or how a vending machine operator may transmit promotional messages. Promotional messages may be limited in terms of content, times of transmission, and/or frequency. Promotional messages may also be limited to particular recipients who have not opted out from receiving such messages. The rules may allow a company to provide employee contact information while receiving assurances that such contact information will not be abused, and that any disruption to employees will be minimal. In various embodiments, a company official may screen promotional messages destined for company employees in order to assure that such messages are within the boundaries of appropriate rules.

According to an embodiment, a vending machine that sells coffee displays a message to a customer (e.g., upon insertion of currency) such as “Thanks for trying our Gourmet Coffee. We would love to alert you when we get new coffee brews. So just give us your email address and your next coffee is free. We promise to email you no more than once per week, and we promise not to give your email address to anyone else.”

In response, the customer enters his email address using a touch screen on the vending machine. He then selects a coffee to dispense. Later (e.g., that day) an email message can be transmitted to the customer's email address. The email message can include a subject line such as “Free Gourmet Coffee” and the body of the email message can include a message such as “We hope you enjoyed your coffee this morning. As promised, the next one is on us. Just type in the following code next time you visit the machine: cof9382.”

Subsequently, the customer may enter the code provided into the vending machine (e.g., via a touch screen), and in response the vending machine can provide a coffee for free.

According to an embodiment, a vending machine can be connected to a company's computer network, and can even receive emails sent to a predetermined company email address (e.g., vending.machine.123@companyXYZ.com). The vending machine may determining that sales should be increased through promotions (e.g., significant inventory is predicted to be remaining at the next restock date). The vending machine can, e.g., adjust its prices and compose promotional email messages informing customers of those adjusted prices, such as “Hungry? Come visit Bob's Crunchy Snack Machine right by the elevator. All Crunchy snacks are 50% off for the next two days!!”

According to an embodiment, a vending machine can be directed to provide customers with benefits, such as free or discounted products in exchange for the customer providing his email address. Similarly, a vending machine can be directed to provide customers with benefits, such as free or discounted products, and another will pay for those benefits (e.g., upon reconciliation every restock period).

Various embodiments provide different advantages. For example, In various embodiments, a vending machine operator may increase sales at a vending machine by promoting the vending machine to potential customers via email and/or other communication media. Specifically, in some embodiments a vending machine can market a particular product. In various embodiments, a vending machine operator may open up new markets for a vending machine by deriving additional sales from a customer base that would otherwise be too small.

In various embodiments, an employer may benefit by obtaining a vending machine that could not otherwise be profitably placed in the company. In various embodiments, an employer may use a vending machine as a convenient and low-cost reward mechanism for its employees, thereby potentially increasing productivity.

In various embodiments, a customer or user benefits from the ability to receive information (without having to be proximate to the vending machine) about discounts, free products, and other benefits provided at a vending machine.

### 2. Vending Machines

Generally, a vending machine may comprise a device, or communicate with a device (e.g., a server, a peripheral device, and/or a peripheral device server), configured to manage sales transactions with customers by, among other things, receiving payment from customers, controlling the pricing and/or distribution (dispensing) of goods and/or controlling entitlements to services.

As used herein, a product is a good or service sold by a vending machine. Examples of goods sold at vending machines include beverages (e.g. cans of soda; bottles of water or iced tea) and snacks (e.g. candy bars; bags of chips). Examples of services sold by vending machines include car washes, photography services and access to digital content (e.g. permitting the downloading of MP3 files or cellular telephone “ring tones” to a handheld device such as an iPod™ device or cellular telephone).

As is well known, an operator is used to denote an owner (or agent thereof) of a vending machine. In an embodiment, an operator is a “route driver” or other service person that services one or more vending machines by restocking vending machines, and/or removing or depositing currency in vending machines.

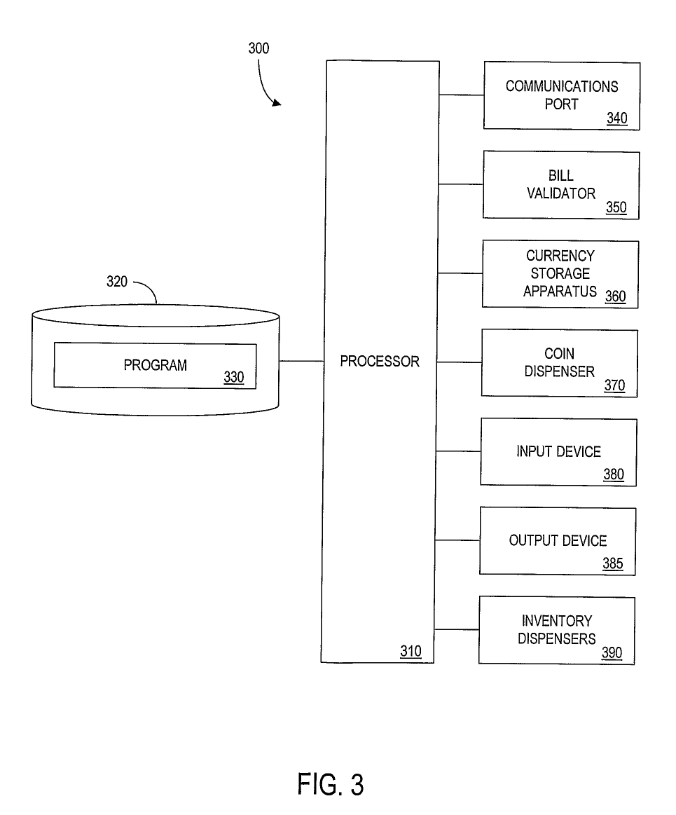

Referring to FIG. 3, one embodiment of a vending machine is depicted. A vending machine 300 may include a processor 310, such as one or more Intel® Pentium® or Centrino™ processors. The processor may include, or be coupled to, (i) one or more clocks or timers, and (ii) one or more communication ports 340 through which the processor may communicate, in accordance with some embodiments, with other devices such as one or more peripherals, controllers and POS terminals. In an embodiment, a communication port may comprise a modem (e.g. a cellular modem or otherwise), a wireless transmitter and/or a transponder (e.g. an infrared transmitter/receiver, a radio transmitter/receiver).

The processor may also be in communication with a data storage device 320. The data storage device may include any appropriate combination of magnetic, optical and/or semiconductor memory, and may include, for example, additional processors, communication ports, Random Access Memory (“RAM”), Read-Only Memory (“ROM”), a compact disc and/or a hard disk. The processor and the storage device may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the vending machine may comprise one or more computers (or processors) that are connected to a remote server computer operative to maintain databases, where the data storage device is comprised of the combination of the remote server computer and the associated databases.

The data storage device stores a program 330 for controlling the processor. The processor performs instructions of the program, and thereby can operate in accordance with an embodiment of the present invention, and particularly in accordance with the methods described in detail herein. An appropriate computer program can be developed using an object oriented language that allows the modeling of complex systems with modular objects to create abstractions that are representative of real world, physical objects and their interrelationships. However, it would be understood by one of ordinary skill in the art that the embodiments of the invention as described herein can be implemented in many different ways using a wide range of programming techniques as well as general purpose hardware systems or dedicated controllers.

The program may be stored in a compressed, uncompiled and/or encrypted format. The program furthermore may include program elements that may be generally useful, such as an operating system, a database management system and device drivers for allowing the processor to interface with computer peripheral devices. Appropriate general purpose program elements are known to those skilled in the art, and need not be described in detail herein.

Further, the program is operative to execute a number of invention-specific, objects, modules and/or subroutines, as disclosed herein.

The program may also direct the processor (possibly in conjunction with one or more peripherals or other devices) to operate with “preprogrammed intelligence”, such as “artificial intelligence”. Among a vending machine's possible intelligent abilities may be the ability to recognize people by voice or image, the ability to understand spoken language, the ability to understand written language, the ability to synthesize spoken language, the ability to compose text, the ability to compose motivational text (such as promotional messages advertising products at the vending machine), the ability to recognize patterns in human purchasing behavior, the ability to sense external “traffic” (i.e., people passing by), and the ability to transmit messages to a targeted group of people on a network.

According to some embodiments of the present invention, the instructions of the program may be read into a main memory of the processor from another computer-readable medium, such from a ROM to a RAM. Execution of sequences of the instructions in the program can cause the processor to perform the process steps of an embodiment of the invention. In alternative embodiments, hard-wired circuitry or integrated circuits may be used in place of, or in combination with, software instructions for implementation of the process steps of an embodiment of the invention. Thus, embodiments of the present invention are not limited to any specific combination of hardware, firmware, and/or software.

A vending machine may comprise payment processing mechanism(s), which may comprise one or more mechanisms for receiving payment and dispensing change (e.g., a coin acceptor, a bill validator 350, a card reader, a magnetic stripe reader, a coin dispenser 370).

In a manner known in the art, a magnetic stripe card reader may read data on the magnetic stripe of a credit or debit card, and it may cooperate with conventional point-of-sale credit card processing equipment to validate card-based purchases through a conventional transaction authorization network. Suitable card-based transaction processing systems and methods are available from USA Technologies, Inc., of Malvern, Pa.

The coin acceptor, bill validator and change dispenser may communicate with a currency storage apparatus 360 (a “hopper”) and may comprise conventional devices such as models AE-2400, MC5000, TRC200 by Mars, Inc. of West Chester, Pa., or CoinCo model 9300-L.

The coin acceptor and bill validator may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled COIN TUBE MONITOR MEANS, the entirety of which is incorporated by reference herein for all purposes. The change dispenser activates the return of coinage to the customer where appropriate. Such apparatus may feature Multidrop Bus (MDB) and/or Micromech peripheral capabilities, as is known in the art.

In another embodiment, a vending machine in accordance with the present invention may be configured to receive payment authorization and product selection commands through a wireless device communication network, directly or indirectly, from a customer device (e.g. a cellular telephone). In such an embodiment, a payment processing mechanism may comprise a cellular transceiver operatively connected to a processor, as described herein. Systems and methods allowing for the selection of and payment for vending machine products through cellular telephones are provided by USA Technologies, Inc. Further, in such an embodiment, a customer cellular telephone may serve as an input/output device, as described herein.

Further details concerning vending machine payment processing mechanisms are well known in the art.

A vending machine may further comprise one or more output devices 385 and one or more input devices 380. Any number of output devices and/or input devices may be included in the vending machine.

In accordance with embodiments of the presenting invention, a vending machine may include an input device for receiving input from a customer, operator, or other person. Also, a vending machine may include one or more output devices for outputting product and/or other information to a customer or operator.

Many combinations of input and output devices may be employed in accordance with embodiments of the present invention. For example, in embodiments which feature touch screens (described herein), input and output functionality may be provided by a single device.

As described, a vending machine may include more than one input device. For example, a vending machine may include an exterior input device for receiving customer input and an interior input device for receiving operator input. In some embodiments, however, the input device provides the dual functionality of receiving input data from both operators and customers.

As also described, a vending machine may comprise more than one output device. For example, a vending machine may include both a Liquid Crystal Display (LCD) screen and several Light Emitting Diodes (LEDs).

An output device may comprise, for example, an LCD and/or one or more LEDs displays (e.g., several alphanumeric LEDs on the shelves of a vending machine, each LED being associated with a row of product inventory).

In one embodiment, an LED display screen may be mounted to a vending machine (e.g., attached thereto, such as via bolts or other mounting hardware). Such a mounted LED display screen and may be used to communicate messages (described herein) to customers. A suitable LED display screen for such an embodiment may be housed in an aluminum case having a length of 27.5″, a height of 4.25″, and a depth of 1.75″. Such a display screen may have a display area capable of showing 13 alphanumeric and/or graphical characters. Further, such an LED display screen may comprise a serial computer interface, such as an RJ45/RS232 connector, for communicating with a processor, as described herein. Further still, such an LED display may be capable of outputting text and graphics in several colors (e.g., red, yellow, green).

Further, in some embodiments, an output device comprises a printer. In one embodiment, a printer is configured to print on card stock paper (e.g. 0.06 mm to 0.15 mm thickness), such as the EPSON EU-T400 Series Kiosk Printer. Further, a printer may be capable of thermal line printing of various alphanumeric and graphical symbols in various font sizes (e.g. raging from 9 to 24 point) on various types of paper. Additionally, such a printer may communicate with a processor (described herein) via an RS232/IEEE 12834 and/or bi-directional parallel connection. Such a printer may further comprise a 4 KB data buffer.

Additionally, in some embodiments, an output device comprises an audio module, such as an audio speaker, that outputs information to customers audibly. Speakers may comprise conventional speakers or modem hypersonic speakers. An output device may include unidirectional or hypersonic speakers which can selectively focus sound to particular locations or customers, while not disturbing others who are not in the location of the focused sound. For a description of such speakers, see Suzanne Kantra Kirschner, “We've heard hypersonic sound. It could change everything”, Popular Science, available at http://www.popsci.com/popsci/science/article/0,12543,351353,00.html.

In some embodiments, an output device may comprise a physical device having a game theme, such as a spinning “prize wheel” similar to those featured on the television game show “Wheel of Fortune™” or “The Price is Right™”, a roulette wheel, mechanical slot machine reels, or the like.

Such a wheel may communicate to customers various information. For example, the wheel may spin and stop on an icon which represents, e.g., a prize entitlement. A physical wheel in the general appearance of the wheel on the “Wheel of Fortune” game show may be attached to a vending machine.

Besides a wheel, another output device which is a peripheral device attached to and in communication with the vending machine can communicate game-related information. By utilizing such an output device, conventional vending machines could be retrofitted with a separate device to employ game-themed promotions. The use of removable peripheral devices may be important in certain situations (e.g., where doorways to interior locations are low), as such satellite devices may be removed during transport and attached once vending machines are brought to the intended location. Likewise, such peripheral devices may be side-mounted, where the ceiling height may impair other location of the peripheral. Further, the use of a separate device is advantageous in that it may be in communication with more than one vending machine, allowing many machines to participate in game-themed vending promotions.

The vending machine can include standard network interfaces (e.g., ports for interfacing the vending machine with wire-based or wirelessly-based communication networks). Such ports allow the vending machine to, e.g., send and receive messages according to a number of formats, such as SMTP or POP email transmissions.

An input device may comprise one or more of (1) a set of alpha-numeric keys (or other keys) for providing input (e.g., character input) to the vending machine, such as the Programmable Master Menu® Keypad, (2) a selector dial, (3) a set of buttons associated with a respective set of item dispensers 174, (4) a motion sensor or other sensor 176, (5) a barcode reader, (6) a Dual-Tone Multi-Frequency (DTMF) receiver/decoder, (7) a wireless device (e.g. a cellular telephone or wireless Personal Digital Assistant), (8) cameras, such as digital video and/or digital still photographic cameras, (9) a voice recognition module, (10) a fingerprint reader, (11) a topical facial pattern scanner/reader, (12) an iris or retinal scanner, (13) a microphone, (14) an infrared receiver, and/or (15) any other device capable of receiving a command from a user and transmitting the command to a processor.

As described, in some embodiments, a touch-sensitive screen may be employed to perform both input and output functions. Suitable, commercially available touch screens for use in accordance with the present invention are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inch (2 mm). The sensitivity resolution of such touch screens may be more than 100,000 touchpoints/in² (15,500 touchpoints/cm²) for a 13-inch touch screen. For such touch screens, the touch activation force required to trigger an input signal to the processor (described herein) via the touch screen is typically 2 to 4 ounces (57 to 113 g). Additionally, touch screens for use in accordance with embodiments of the present invention may be resistant to environmental stressors such as water, humidity, chemicals, electrostatic energy, and the like. These and other operational details of touch screens (e.g., drive current, signal current, capacitance, open circuit resistance, closed circuit resistance, etc.) are well known in the art.

A vending machine may further comprise one or more inventory storage and dispensing mechanism(s) 390. Product inventory storage and product dispensing functions of a vending machine configured in accordance with a snack machine embodiment of the present invention may include one or more of: (i) a drive motor, (ii) metal shelves, (iii) a product delivery system (e.g. a chute, product tray, product tray door, etc.), (iv) dual spiral (i.e. double helix) item dispensing rods, (v) convertible (i.e. extendable) shelves, and/or (vi) a refrigeration unit.

In some embodiments, a vending machine may be housed in a casing of the model 129 SnackShop manufactured by Automatic Products™. In such embodiments, three removable shelves may be employed, together providing for thirty product rows and an inventory capacity of between 185 and 522 commonly vended snack products.

Inventory storage and dispensing mechanism(s) may comprise one or more of: (i) metal and/or plastic shelving, (ii) item dispensing actuators/motors, (iii) product delivery chutes, and/or (iv) a refrigeration unit. Further details concerning vending machine inventory storage and dispensing mechanisms are well known in the art.

A vending machine may include or be in communication with a peripheral device. A peripheral device may be a device that obtains (e.g., receives or reads) information from (and/or transmits information to) one or more vending machines. For example, a peripheral device may be operable to obtain information about transactions being conducted at a vending machine, such as the initiation of a transaction, an amount of money deposited for a transaction and/or a product selected during a transaction. For example, a peripheral device may monitor activities carried out by a processor of a vending machine. In one embodiment, one or more of the processor, the input device(s), RAM, ROM, output device(s) and a data storage device may be included, wholly or partially, in a peripheral device.

An example of a peripheral device is the e-Port™ by USA Teclnologies Inc. The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., promotions and information about their transaction status.

A peripheral device may be operable to receive input from customers, receive payment from customers, display messages to customers and/or exchange information with devices, such as a controller, a POS terminal, another vending machine. A peripheral device may be operable to instruct a vending machine that appropriate payment has been received (e.g., via a credit card read by the separate device) and/or that a particular product should be dispensed by the vending machine. Further, a peripheral device may be operable to instruct the vending machine to execute process steps and/or output messages. Further, a peripheral device may be operable to instruct the vending machine to execute game-themed promotions or price changes.

The functions described herein as being performed by a peripheral device controller and/or a peripheral device may, in an embodiment, be performed by the controller (in lieu of or in conjunction with being performed by a peripheral device controller and/or a peripheral device).

In an embodiment, a peripheral device may be useful for implementing the embodiments of the present invention into the operation of a conventional vending machine. For example, in order to avoid or minimize the necessity of modifying or replacing a program already stored in a memory of a conventional vending machine, an external or internal module that comprises a peripheral device may be inserted in or associated with the vending machine. For example, a conventional vending machine may be retrofitted with a peripheral device in order to implement an embodiment of the present invention.

A peripheral device may include (i) a communications port (e.g., for communicating with one or more vending machines, peripheral device controller, another peripheral device, and/or controller); (ii) a display (e.g., for graphics and/or text associated with a promotion), (iii) another output means (e.g., a speaker, light, or motion device to communicate with a customer), (iv) a benefit providing means (e.g., a printer and paper dispensing means), and/or (v) an input means.

In an embodiment, the peripheral device may direct a vending machine to perform certain functions. For example, a program stored in a memory of peripheral device may cause a processor of a vending machine to perform certain functions. For example, a program stored in a memory of peripheral device may cause a processor of a vending machine to dispense one or more products, dispense a monetary amount, refrain from dispensing a monetary amount, refrain from outputting a product, and/or communicate with another device.

Note that, in an embodiment, a vending machine and a peripheral device that is associated with the vending machine may not communicate with one another at all. In some embodiments, however, each may communicate with a computer or other device. For example, a vending machine may communicate with a controller and an associated peripheral device may communicate with a controller. For example, if both the vending machine and the peripheral device are in communication with a controller, each may obtain information associated with the other through the controller.

A vending machine may include a cabinet constructed from, for example, any combination of (1) commercial grade (e.g., sixteen-gauge) steel (e.g., for exterior panels and internal shelving), (2) transparent materials such as glass or Plexiglas (e.g., for product display window), (3) rubber (e.g., for waterproofing insulation), (4) plastic, (5) aluminum, and/or (6) any suitable material.

Many commercially available machine cabinets can be modified to work in accordance with the embodiments of the present invention. For example, in snack machine embodiments, a suitable machine casing may comprise the 129 SnackShop™ manufactured by Automatic Products International, Ltd.™ of Saint Paul, Minn., which stands at 72″/1829 mm wide, has a width of 38⅞″/988 mm, and a depth of 35″/889 mm. Other suitable snack machine casings include the A La Carte™ machine from Automatic Products™, and the GPL SnackVendor™ model # 159 from Crane Merchandising Systems/Crane CO.™ of Stamford, Conn.

In beverage machine embodiments, machine cabinets commercially available from Dixie Narco™, Inc. of Williston, S.C. may be employed. Beverage machine cabinets may comprise a “cooler” or “glass front” style front panel, featuring a transparent front panel (e.g. glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Other embodiments are contemplated as well, including combination snack and beverage vending machine embodiments, such as those available from Crain Co.™. Further details concerning the suitability of machine casing/cabinetry are well known in the art, and need not be described in further detail herein.

Embodiments of the present invention can be configured to work in a network environment including a computer that is in communication, via a communications network, with one or more vending machines. The computer may communicate with the vending machines directly or indirectly, via a wired or wireless medium such as the Internet, LAN, WAN or Ethernet, Token Ring, or via any appropriate communications means or combination of communications means. One or more of the vending machines may comprise computers, such as those based on the Intel® Pentium® processor, that are adapted to communicate with other computers. Any number and type of machines may be in communication with any computer.

Communication between the vending machines and the computer, and among the vending machines, may be direct or indirect, such as over the Internet through a Web site maintained by computer on a remote server or over an on-line data network including commercial on-line service providers, bulletin board-systems and the like. In yet other embodiments, the vending machines may communicate with one another and/or the computer over RF, cable TV, satellite links and the like.

Some, but not all, possible communication networks that may comprise the network or be otherwise part of the system include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that vending machines and/or computers in communication with each other need not be continually transmitting to each other. On the contrary, such vending machines and/or computers need only transmit to each other as necessary, and may actually refrain from exchanging data most of the time. For example, a vending machine in communication with another machine via the Internet may not transmit data to the other machine for weeks at a time.

In an embodiment, a server computer may not be necessary and/or preferred. For example, embodiments of the present invention may be practiced on a stand-alone vending machine and/or a vending machine in communication only with one or more other vending machines. In such an embodiment, any functions described as performed by the computer or data described as stored on the computer may instead be performed by or stored on one or more vending machines.

In other embodiments, a vending machine may be in communication with a remote computer, such as a server, that provides the vending machine with and/or receives from the vending machine, e.g., all or some of the data and/or functionality described herein. Thus, in certain embodiments, the server may comprise certain elements or portions of certain elements such as a data storage device/memory.

In such an embodiment, a remote computer could be accessible, directly or indirectly, via a second computer (communicating over the Internet or other network) by a customer or another operator. Accordingly, a customer or other operator of the second computer (e.g. an owner of the vending machine) could communicate with the remote computer via a Web browser. The second computer could, e.g., receive from the remote computer messages described herein as being output by the vending machine, and/or transmit to the remote computer input described herein as being provided to the vending machine. Similarly, various data described herein as received through an input device of a vending machine may be received through a Web browser communicating with a remote server, which in turn communicates with the vending machine. Thus, an owner/operator of the vending machine can operate a remote device to remotely poll and/or report; to transmit new business rules to the vending machine; and the like.

In one embodiment, a software-based control system executes instructions for managing the operation of the vending machine, and in particular in accordance with the inventive functionality described herein. Such vending machine operations include, but are not limited to: (1) item pricing (e.g. displaying prices via an LED, changing such prices where appropriate, etc.), (2) processing vending transactions by (i) receiving customer selections via an input device, (ii) processing payment via a payment processing mechanism, and (iii) actuating corresponding item dispensing mechanisms, (3) configuring benefit offers, (4) outputting benefit offers to customers via output devices (including display of game-themed graphics/content on LCD and LED displays), and (5) recording transaction information (inventory levels, acceptance rates for promotions, etc.).

In some embodiments, machine peripherals (e.g. machine hardware, including mechanical hardware such as input devices, output devices, inventory dispensing mechanisms, and payment processing mechanisms including coin acceptors, bill validators, card readers, change dispensers, etc.) will be controlled by the software-based control system through a standard RS-232 serial interface. In such embodiments, embedded API/devices may be used to enable the software to actuate/control vending machine peripherals via RS-232 connectivity. Such vending machine peripherals may be operatively connected to the control system directly or indirectly, in any manner that is practicable.

In one embodiment, control software can be divided into three abstract components. Such division may provide a clear partition of tasks, which may be desirable so that any future modification and new programming can be applied without disrupting other components. The three abstract components include a Business Logic component, a Control Layer component, and an exemplary Machine Peripheral component. More machine peripherals may be employed. The Business Logic component is connected to Control Layer component via an API; Control Layer component is connected to Machine Peripheral component via an API.

The Business Logic component visually represents the portion of the software that determines benefit offers, as discussed herein. Such a component may access a rules database and an inventory database to perform such functions. The Control Layer component visually represents the portion of the software which interfaces with at least one Machine Peripheral component, and thereby transmits commands to perform such functions as: (i) outputting offer information via an output device (i.e. a Machine Peripheral component), (ii) dispensing products via a product dispensing mechanism (i.e. a Machine Peripheral component), (iii) dispensing change due to a customer via a payment processing mechanism, which may include a change dispenser and a currency storage apparatus (i.e. several Machine Peripheral components). As stated, the Machine Peripheral component generally represents machine hardware, including mechanical hardware such as input devices, output devices, inventory dispensing mechanisms, and payment processing mechanisms including coin acceptors, bill validators, card readers, change dispensers, etc.

### 2.1 Example System Architecture

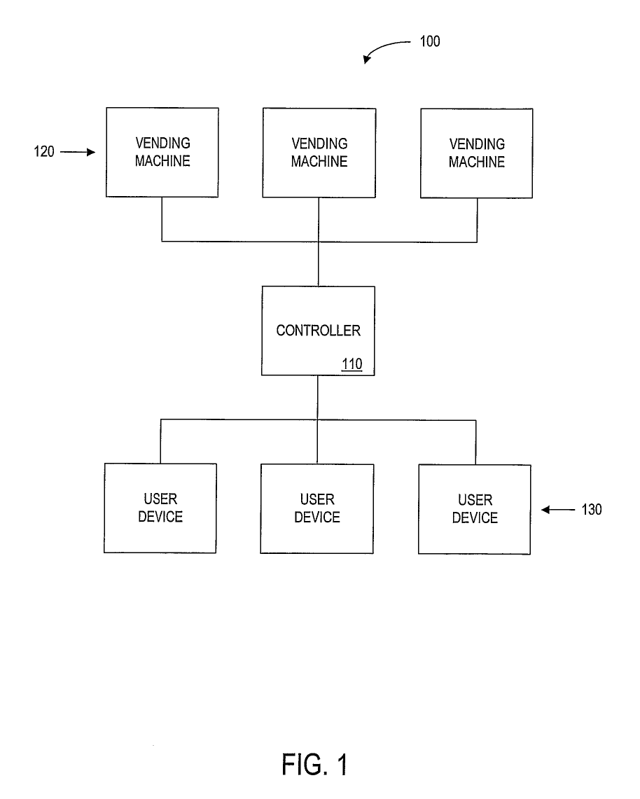

Referring to FIG. 1, a system 100 include a controller 110 in communication with one or more vending machines 120 and one or more user devices 130. The controller, vending machines, and user devices may be in communication with one another via one or more networks such as the Internet, a cellular telephone network, a local area network, a wireless network, and the like.

The vending machine may incorporate some or all of the functions of the controller. In some embodiments, a separate controller is not included, as one or more vending machines performs (individually or collectively) all of the functions of the controller.

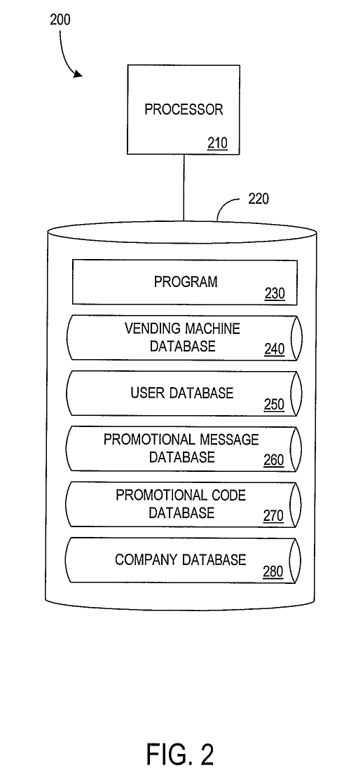

Referring to FIG. 2, a controller 200 (which may be, e.g., a computer, a server or the like) includes a processor 210 in communication with a memory 220. The memory 220 stores a program 230 for directing the controller (e.g., as described herein, as necessary to direct the controller to operate). The memory 220 also stores one or more databases, such as a vending machine database 240, a user database 250, a promotional message database 260, a promotional code database 270 and a company database 280. These databases are described in detail herein.

### 3. Various Processes

### 3.1 Receive a List of Email Addresses

In an embodiment, the controller may receive a list of email addresses of company employees. The list may include an email address for all employees, or for a subset of company employees. In addition, if a company employee has multiple email addresses, then the controller may receive one or more of the employee's email addresses.

Such a list may be (1) input to the controller by an operator (e.g., who received such a list directly); or (2) received by the controller via, e.g., a Web interface, such as when a company representative transfers a file of email addresses to the controller utilizing a Web interface or email. Other methods of receiving a set of email addresses are known and within the scope of the present invention.

In some embodiments, a controller may receive other contact information for employees in addition to or instead of email addresses. Such contact information may include desk phone number, home phone number, mobile phone number, pager number, instant messenger handle, chat room handle, Website address, etc. Contact information may also include a postal address, such as a work address, home address, or other address.

In some embodiments, the controller may receive a single piece of information representing contact information for more than one employee. For instance, the controller may receive a “list address” or the like, such that any email sent to the list address is automatically forwarded or provided to the email addresses of individual employees associated with the particular distribution list. For example, a list may allow contact with certain groups according to the function a1 unit (e.g., the marketing group) or according to location (e.g., 3^{rd} floor employees. The controller need not be aware of the individual email addresses that form a part of the list.

In various embodiments, the list of email addresses or other employee contact information may facilitate a function of the controller. The list of email addresses may allow the controller to send promotional messages to the employees. The promotional messages may encourage the employees to transact with a vending machine that the controller intends to place at the company offices. The controller may thereby expect to generate more sales per employee at a vending machine placed inside the company offices than the controller could hope to make without the ability to send email messages to the employees.

According to an embodiment, a vending machine can be directed to provide customers with benefits, such as free or discounted products in exchange for the customer providing his email address. Thus the vending machine can prompt email addresses to be input in exchange for the benefit of various promotions (as described herein).

### 3.2 Receive Restrictions on Communicating/Interacting/Contacting

In various embodiments, a company may place limits, rules, or restrictions upon when the controller may send messages to the company employees. The restrictions may, e.g., be structured to protect company employees from excessive numbers of emails. The restrictions may also be structured to discourage the controller from distracting the employees during work hours (e.g., by encouraging the employees to get up from their desks to go to the controller's vending machine). Restrictions may further be structured to protect the company's employees from types of messages that may be deemed inappropriate for a work environment.

The following are some example restrictions that may be placed upon the controller with regards to sending messages, such as email messages, to company employees:
a. Messages are permitted to be sent only (or are not permitted to be sent) during certain hours, days of the week, time periods.
b. Messages are permitted to be sent only (or are not permitted to be sent) to certain employees.
c. A limit (e.g., one message per day) on the number of messages sent to an employee per unit of time.
d. A limit (e.g., five messages during any one-hour period) on the total number of messages sent out per unit time.
e. Messages are restricted to a certain size or less (e.g., as measured in bits, bytes, lines of text).
f. Messages are restricted from containing certain words, such as e.g., common vulgar words.
g. Messages are restricted from containing content of a violent, mature, or racially insensitive nature.
h. Messages are restricted from containing content concerning various controversial topics, such as politics, abortion, religion, etc.
i. Messages are restricted to topics related only to one or more vending machines (e.g., relating only to the vending machine placed by the operator in the company offices, relating only to what the vending machine vending machine has in inventory).
j. Messages may be restricted as to their origin. For example, messages must always originate from a particular sender (e.g., an email address thereof), such as an email address of the controller.
k. Messages must be clearly marked as having been sent by the vending machine or by the controller. For example, messages must contain “Vending” as the first word in the subject line of the email, or as the first word of the message body. With this restriction, employees may more readily filter or avoid messages from the vending machine if desired.

The above (and other) restrictions may be received via a Website of the controller. For example, a company representative may visit the Website and may enter in one or more restrictions electronically (e.g., through known web browser graphical user interface components). There may be a predetermined HTML form for entering restrictions. For example, the company representative may be able to check boxes next to the hours that promotional emails are permitted. Alternatively, restrictions may be entered freely, such as via a block of text. Additionally, restrictions may be communicated by any other practical means (e.g., by postal mail, facsimile, telephone) to the operator, who in turn converts (if necessary) these restrictions to a form that the controller may employ.

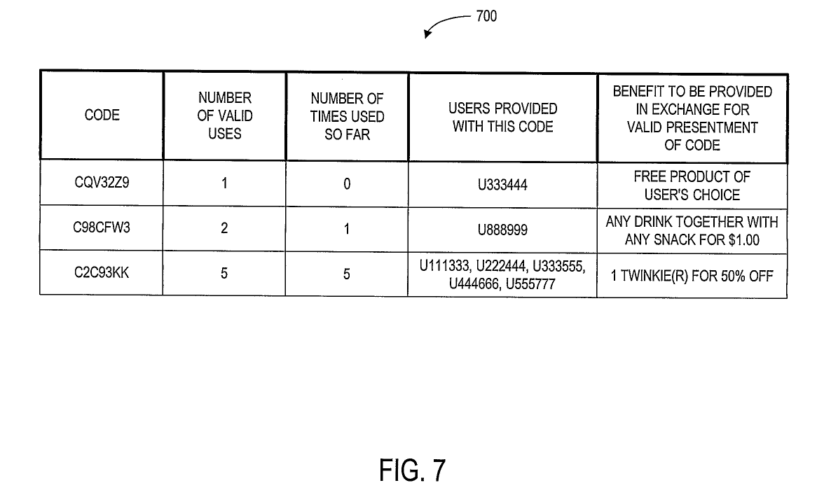

Restrictions may be stored in a database accessible by the controller and/or by a vending machine. The database of FIG. 7 depicts a set of example stored rules, each rule being associated with a company where the controller has, or is contemplating placing a vending machine. Prior to transmitting promotional message to employees of a company, the controller may access a database that defines the applicable restrictions, and in turn determine if it is permissible to send the message in light of the applicable restrictions.

In some embodiments, communication from the controller may be directed to one or more “proxy” email addresses, rather than other email addresses in use by the employee/the company. For example, employee John Doe, whose real email address is jdoe@company.com, a proxy email address of jmx34@company.com. Emails sent to a proxy address may be forwarded (in a known manner by a company server or by other well known means) to the actual address corresponding to the proxy address.

For instance, the controller may send an email to the address jmx34@company.com. The server at the company may then automatically associate or translate the address jmx34@company.com to jdoe@company.com using e.g., a table of proxy and corresponding actual email addresses. The server at the company may then send/forward the email to John Doe via the actual address of jdoe@company.com. The use of proxy email addresses maybe safeguarded against abuses, such as the unauthorized selling or dissemination of email addresses to marketers. If desirable, the company may readily discontinue the use of the proxy addresses, or otherwise sever the link between the proxy addresses and the actual addresses. The actual addresses would then be protected from unwanted email messages.

### 3.3 Determine a (Promotional) Message for the Vending Machine

The controller may determine/generate/select a message (e.g., a promotional message) for transmission to one or more targets (e.g., company employees). In various embodiments, a promotional message may include content which encourages company employees to make a purchase from the vending machine. A promotional message may include various information, such as is described herein, alone or in various combinations.

Promotions may be generated based upon one or more price management factors or revenue management factors. For example, the use of price management factors in creating promotions (e.g., discounts) at a vending machine is described in U.S. patent application Ser. No. 08/947,798, filed Oct. 9, 1997, entitled METHOD AND APPARATUS FOR DYNAMICALLY MANAGING VENDING MACHINE INVENTORY; and in U.S. patent application Ser. No. 10/902,397 filed Jul. 29, 2004, entitled PRODUCTS AND PROCESSES FOR VENDING A PLURALITY OF PRODUCTS and in U.S. patent application Ser. No. 10/966,407, filed Oct. 15, 2004 entitled PRODUCTS AND PROCESSES FOR MANAGING THE PRICES OF VENDING MACHINE INVENTORY. Each of these applications is incorporated herein by reference.

Alternatively, an operator or other person may generate or select a message, or may alter the contents of a message generated by the controller or by another. For example, a company representative may visit a Website of the operator which provides an interface for specifying (a) a message, (b) desired graphics, and (c) the times and dates during which the message is to be displayed.

Such messages specified by company representatives may be promotional messages (e.g., for the vending machine). Alternatively, such messages may be company specific, such as a general reminder (e.g., of an upcoming meeting), an advertisement for an upcoming social event, a reminder to submit checks for reimbursement, a reminder to turn in time sheets, a congratulatory message (e.g., if it is an employee's birthday or if an employee has just had a baby), a message of praise (e.g., for an employee or group of employees that has done good work), or any other message of relevance to a company.

Such messages specified by company representatives may provide benefits (e.g., discounted products, free products) to employees, e.g., for purposes of rewarding or showing recognition to employees. Such benefits may be paid for by the company in a known manner.

A promotional message may include information indicating a price of a product available at the vending machine, or the occurrence of a reduced price of a product. For example, a promotional message may indicate that a package of potato chips may be purchased for 50% off during the next hour. A promotional message may include information indicating the availability of a package deal. For example, a promotion may indicate that a customer may purchase both a soft drink and a snack for only one dollar.

A promotional message may include information indicating the duration of any discount, special offer, or other promotion. For example, the promotional message may indicate that all carbonated drinks are two for the price of one for the next ten minutes.

A promotional message may include information indicating the start or end time of a promotion. For example, a promotion may not take effect until one hour after a message is sent. Thus, a person may receive a promotional message at 3:00 PM that states: “Tortilla Chips are 50% off starting at 4:00 PM”. Similarly, a promotional message may indicate the end time of a promotion. For example, a promotional message may indicate that Tortilla chips will be 50% off until the end of the day. In various embodiments, a promotional may end at the time of the next restocking. Thus, for example, potato chips may be 60% off until the vending machine is restocked next time. Advantageously, this would allow a promotion to remain in effect only long enough to clear out as much old inventory as possible before a restocking event.

A promotional message may include information indicating the availability of a supplementary prize. For example, the message may indicate that a customer may obtain a free ticket to a club with any purchase at a vending machine.

A promotional message may include information indicating the availability of various information, such as news information, entertainment, educational information, and so on. For example, the message may indicate that Britney Spears' new music video is playing on the display screen of the vending machine. As another example, the message may indicate that there is breaking news about an approaching hurricane being shown on the display screen of the vending machine.

A promotional message may include information indicating a way in which further information may be obtained. For example, the promotional message may include information regarding a web site or web content; and/or a code which, when entered, allows access (or a particular level of access) to a web site or web content. The web site may provide any information desired, such as information which may be appropriate for promotional messages (e.g., information indicating a price of a product available at the vending machine).

A promotional message may include information indicating the availability of a product, or the impending availability of a product, and/or the relative availability (e.g., quantity remaining) of a product. For example, a promotional message may indicate that Tiffany's Fine Chocolates are now in stock, that Cokes® are out of stock, or that the stock of potato chips has just been replenished. A promotional message may also offer a benefit that is of limited quantity. Therefore, the promotional message may indicate that only ten promotions are available. For example, “Twinkies® are two for the price of one. Hurry, there are only eight Twinkies® left in stock.”

A promotional message may include information indicating a particular vending machine (e.g., of a plurality within an office building). For example, a promotional message may indicate that Snickers® candy bars are available at the Mars® Vending Machine. In various embodiments, promotional messages may promote only a single vending machine, or only a subset of vending machines. Thus, there may be only two vending machines at which a person might receive the benefit of a promotion.

A promotional message may include information indicating a location of one or more vending machines, such as “the snack machine is on the first floor and the beverage machine is in the lobby” or “the vending machine in the main lobby”.

A promotional message may include information indicating directions to a vending machine, either generically or from each of a plurality of staring locations, such as “from the lobby, take the elevator to the second floor of the building, and go to the right to find the vending machine”.

A promotional message may include information indicating a particular vending machine among several which an employee may visit. For example, an office may contain several vending machines. A promotional email may indicate that an employee should visit a first vending machine rather than a second, because the first still has a particular product in stock. For example, “If you are looking for Rice Bars, visit the vending machine in the kitchen. The vending machine in the lobby is out.” A promotional message that steers an employee towards a particular vending machine may help the controller to manage inventory simultaneously at multiple vending machines. One advantage is that a controller can encourage usage such that all vending machines run out of products at approximately the same time. In this way, a fill person may refill all vending machines at once during the same trip.

A promotional message may include information which is customized, e.g., customized to the recipient, customized to the company of the recipient. For example, a message sent to a particular employee may contain the employee's name in the greeting. A message sent to a group of employees of a company may contain the company's name. A message may also make reference to an employee's purchase history or to other known information about the recipient. For example, a message might say, “Hey Bob, your favorite snack, Aunt Susan's Honey Butter Cookies, is now twenty percent off!”

A promotional message may include information indicating any other recipients of a promotional message. For example, a promotional message may indicate that thirty other people are receiving the same message. Therefore, the message may indicate that the person should hurry to obtain the promotional benefit before all of the benefits are given away to other recipients of the message.

A promotional message may include information indicating a status of a subscription. In various embodiments, a user may purchase a “subscription” to a vending machine, as described, e.g., in U.S. Pat. Nos. 6,298,972, 6,085,888, and 5,988,346, each of which is incorporated herein by reference. A subscription may allow a user to pay upfront for a number of items, with the items to be obtained over a number of transactions. For example, a user may purchase a subscription that allows him to obtain one soda per week for the next ten weeks. A promotional message may indicate the status of a subscription by, e.g., indicating the number of units of the subscription left to be redeemed, that it has been more than a predetermined time since the subscription was used. For example, a promotional message may indicate that a user still has four items in the subscription left to be redeemed. A promotional message may also warn a customer that he must pick up a certain item within a certain time period, or he will no longer be able to. For instance, if a customer has subscribed to receiving one soda per week, the customer may be unable to receive one of his sodas if a given week passes without any redemptions.

A promotional message may include information indicating special instructions for a consumer. For example, instructions may direct the recipient to interact with two vending machines (e.g., pursuant to a promotion). Such a promotion might indicate that a consumer may take a first item from a first vending machine, and a second item from a second, adjacent vending machine, for only 75% of the combined price of the two items. A consumer may be unaccustomed to receiving items from two separate vending machines as part of the same transaction. Thus, the promotion might emphasize that the consumer must take a product from each of two or more vending machines. In some embodiments, instructions might indicate that the customer is to pay for a transaction at a first vending machine, and to receive a product at a second vending machine.

A promotional message may include information indicating a sweepstakes entry. For example, a promotional message may provide a code to a consumer. The promotional message may further indicate to the user to bring the code to a vending machine in order to see whether he has won. The consumer may later visit the vending machine and enter the code. If the consumer has won, then the vending machine may arrange for the consumer to receive a prize. For example, the vending machine may arrange for a check to be sent to the user. An added benefit for the controller is that the consumer may be encouraged to visit the vending machine.

A promotional message may include information indicating a gift certificate or like award. For example, a promotional message may include a portion (e.g., a bar code) that a person may print out and insert into the vending machine (e.g., in order to receive products at no cost). The printed portion may, for example, contain a bar code that is readable by the vending machine in order to allow the vending machine to determine an amount associated with the gift certificate. The gift certificate may alternatively consist of one or more codes that may be input to the vending machine in return for benefits, such as free or discounted products. A gift certificate may be sent by the controller as a reward for frequent purchases, or as an incentive to try a vending machine. A gift certificate may also be paid for by a first user and provided to a second user. For example, if it is someone's birthday, then other employees in an office may chip in to purchase a gift certificate. A representative of the gift-givers may take the aggregated money and insert it into the vending machine. The representative may indicate an identifier for the recipient of the gift certificate, such identifier possibly including an email address. The vending machine may then transmit the gift certificate to the recipient at, e.g., his email address. A gift certificate may be paid for by many others, including a company official, who wishes to reward an employee. Note that a gift certificate may include a note from the givers, such as, “Happy Birthday!” Note that a gift certificate may also be provided in hard copy directly from a vending machine. For example, a giver may insert money, retrieve a printed gift certificate from a vending machine, and physically give it to a recipient. A giver may also insert money and indicate to a vending machine that a gift certificate should be provided to a recipient the next time the recipient transacts at the vending machine.

In various embodiments, a code which is included in a message may consist of a sequence of characters or character combinations that may be entered via keys at a vending machine. Accordingly, it can be advantageous to have the character set of the code is based on the vending machine(s) where the code is intended to be redeemed.

For example, a vending machine may have a keypad of keys labeled “A1”, “A2”, “C3”, and so on. These labels reference a row and column from which a purchaser would typically select a snack. For instance, “C3” may refer to the snack in the third row and third column of the vending machine. Thus, a code may consist of sequences of such character combinations, such as “A2-D5-F3”, which permits entry of the code by pressing the keys at the vending machine in the proper sequence. In some cases, a vending machine may contain only numeric keys. In such cases, codes may consist of just sequences of numerals.

A promotional message may include a code that is redeemable only a particular vending machine, or at a particular set of vending machines.

A code may be made invalid after being redeemed in transactions a predetermined number of times. For example, each code may become invalid after only one use. To facilitate a restricting the number of uses for codes, the vending machine and/or the controller may maintain a database of valid codes, such as the database of FIG. 7. When a code is inputted, the vending machine may determine whether it is a valid code. If the code is valid, then the vending machine may allow the current customer to receive a benefit associated with the code. The vending machine may then update the code in the database by e.g., recording one more use for the code. If the code has been used its maximum number of times, then the vending machine may designate the code as invalid in the database, thereby preventing its further use.

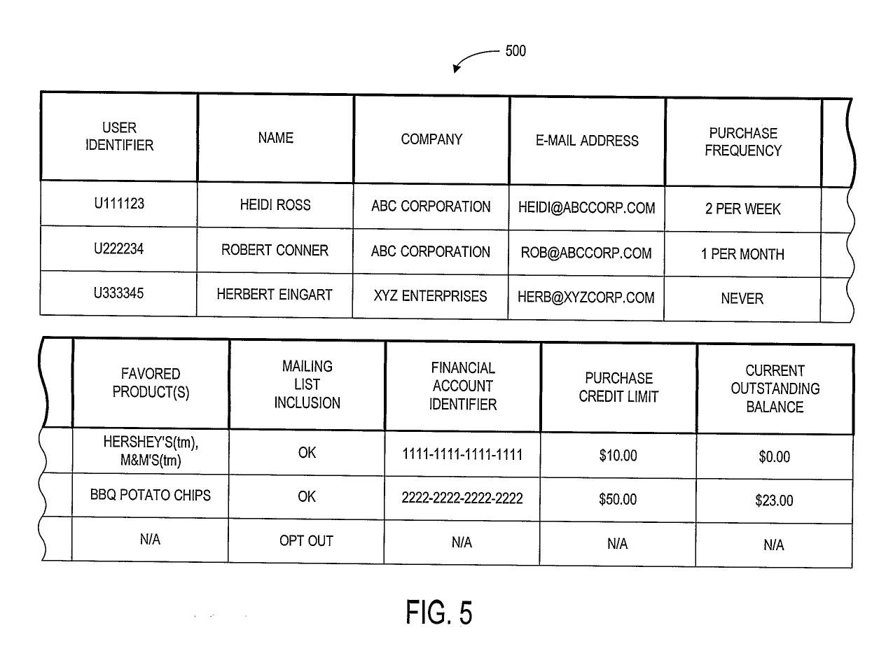

Additionally, the controller may send a unique code to each recipient of a promotional message. The controller may track which recipient received which code. After redemption of such a code, the vending machine may inform the controller of its redemption. Thus, the controller may track the purchases made by a particular recipient. For example, the controller may maintain and periodically update a user database such as the database of FIG. 5. The database may include preferred products for the user, frequency of purchase, average transaction amount, preferred times of purchase, preferred days of purchase (e.g., Mondays), etc. The controller may use knowledge of a person's purchasing preferences and purchasing habits to tailor promotional messages to the person. For instance, promotional messages may highlight certain preferred products, or may be sent only during days when the user normally transacts with the vending machine.

A promotional message may include information indicating a benefit from a party other than the operator (e.g., a cross promotion with a third party merchant). Such benefit can granted in exchange for transactions with a vending machine. For example, a person may receive a gift certificate redeemable at Amazon.com with every purchase of a candy bar at the vending machine. In another example, a person may receive a free candy bar or other vending machine item in return for buying a gift certificate at Amazon.com.

A promotional message may promote other merchants besides the operator, and/or other products besides those sold in a vending machine. For example, a message might read, “Twinkies® are 30% off today at the vending machine. If you get some Twinkies® cream on you, don't worry, because Tide® liquid laundry detergent can remove the stain in no time.” The controller may receive a payment from the makers or sellers of other products or services it promotes in its promotional messages.

In some embodiments, a controller may offer in a promotional message a benefit, such as a free product at the vending machine, if a consumer is willing to receive one or more messages from a third-party merchant. The controller may also offer a benefit if a consumer will allow the promoter to provide the consumer's email address to a third-party merchant. Embodiments for encouraging a customer to review a marketing promotion or to participate in a survey are described in U.S. Pat. No. 6,161,059, entitled “Vending machine method and apparatus for encouraging participation in a marketing effort”, which was issued on Dec. 12, 2000, and which is incorporated herein by reference.

A promotional message may include information indicating that a vending machine is operable to sell items on behalf of third-party merchants. For example, a vending machine may include an appropriate interface (e.g., flat panel display, keyboard, pointing device) which allows a person to access Web sites or the Internet in general. The interface can permit certain Websites to be accessed (e.g., web sites of on-line merchants which permit on-line purchases), and even restrict access to only one or more of such third-party sites. Such an embodiment is advantageous in that a credit card number or other financial account number need not be provided to the web site to render payment. Instead, the vending machine can verify to the web site that payment has been made (e.g., by the customer depositing currency in a bill reader of the vending machine). An appropriate amount of funds may be paid to the on-line merchant (e.g., by the operator, automatically by the controller) via any known means such as wire transfer, or credit card account payment using an account such as the operator's account.

A promotional message may include information indicating that an entry in a game. In various embodiments, a vending machine may conduct (or facilitate participation in) any type of game. In one embodiment, the entry may be conferred only in exchange for a purchase via the vending machine, or a specific type of such a purchase. For example, a customer may make a purchase at a vending machine, after which a game wheel (e.g., displayed on a video display device, an actual physical wheel) is spun. The game wheel may have various outcomes, one or more of which may result in a benefit such as a free product. To enter the game, the employee may bring a code from his promotional message to the vending machine. Alternatively, the employee may enter an identifier whereupon the vending machine may recognize the identifier and conduct the game. Games at vending machines are described in co-pending U.S. patent application No. [NOT YET ASSIGNED], (Attorney Docket No. 03-048) filed concurrently herewith, entitled “PRODUCTS AND PROCESSES FOR PROMOTIONS WHICH EMPLOY A VENDING MACHINE”, the contents of which are incorporated by reference herein for all purposes.

A promotional message may include information indicating a coupon, such as a coupon that provides a discount for purchases made at the vending machine. Such a coupon may be embodied in a code which, when entered at the vending machine, provides a discounted product or free product. A coupon may also be embodied in a code which can be entered via a web site to update a subscription of an entity.

A promotional message may include information indicating a volume discount. For example, a promotional message may indicate that a free soda is available with the purchase of eight sodas. As another example, a promotional message may indicate that eleven cans of soda may be had for $5, whereas normally only ten cans might be had for $5.

A promotional message may include information indicating an “all you can eat” promotion. For example, for a fixed price a person may obtain as many snack items as desired. The person may, however, be constrained by certain restrictions. For example, the person can take as many snack items as he wants for the next week, so long as he takes no more than one per hour.

A promotional message may include information indicating a membership-type promotion. In such a promotion, a person might pay an upfront fee to become a “member”. As a member, the person may have the privilege of getting a discount on items purchased at the vending machine for the duration of the membership period.

A promotional message may include information indicating a commission based sales system. In such a system, a first person may be encouraged to bring others to transact at a vending machine. The first person may then earn benefits for every transaction made by the others at the vending machine. The first person may also earn benefits for still other people brought to the vending machine by the people the first person has brought. A person may thereby be encouraged to bring as many people as possible to transact at a vending machine.

A plurality of promotional messages may be interrelated, or designed with a collective goal. For example, each of a plurality of promotional messages may provide promotions that are in effect at non-overlapping periods of time. For example, a first promotional message may indicate that beverages are “two for one dollar” until 1:00 PM today. A second promotional message may indicate that beverages are “two for one dollar” from 1:00 PM to 3:00 PM. A third may indicate that beverages are “three for one dollar” from 3:00 PM to 5:00 PM. Therefore, the different promotions will not interfere with each other. As described herein, one manner of limiting the duration of a promotion is to require that an employee enter a code at a vending machine in order receive the benefit of a promotion. The vending machine can be programmed to accept the codes only during the respective periods of time.

A message may be filtered or verified by one or more company employees or other people before it is allowed to be sent to the intended recipient(s). For example, a promotional message may be composed by the controller, and then transmitted another for approval (e.g., the Human Resources Director of the company). The Human Resources director may then read the message and determine whether the message meets appropriate criteria (e.g., does not contains inappropriate language or graphics). If the Human Resources Director is satisfied with the message, then he may forward the message to one or more other company employees who are its intended recipients. Alternatively, he may express approval of the message (e.g., clicking a button on a Web browser interface), after which the controller is permitted to transmit the message directly to the intended recipients.

In an embodiment, a message may be composed or proposed by a person (e.g., an employee) and submitted to the controller for dissemination (e.g., to a particular set of recipients specified by the person). The controller, in turn, may determine whether the message is approved (e.g., submit the message to a Human Resources Director of a company) before distributing the message.

### 3.4 Initiating Transmission of a Message

The outputting of a (promotional) message may be (but need not be) based on various conditions (“triggers”). For example, a promotional message may be output upon a particular condition being satisfied.

In some embodiments, a promotional message may be output upon the decision of, e.g., the operator (e.g., believing such a message will attract more customers or lead to greater profits at a vending machine). A promotional message may be output for purposes of testing (e.g., testing a promotion). If the promotional message is successful in increasing profits at a first vending machine, then the same message may be useful in promoting sales at other vending machines. The use of test promotions, and the propagation of successful test promotions is described in U.S. Pat. No. 6,230,150 B1, entitled “Vending Machine Evaluation Network” which issued on May 8, 2001, and which is incorporated herein by reference.

The outputting of a (promotional) message may be based on the sales of a vending machine (e.g., output if the sales of a vending machine or a set of vending machines are below a threshold). An appropriate promotional message would be one that was intended to increase sales of the vending machine or set of vending machines.

The outputting of a (promotional) message may be based on the scheduled restock date of a vending machine being less than a predetermined amount of time in the future. An appropriate promotional message would be one that was intended to encourage the sale of as many items as possible prior to the restocking.

The outputting of a (promotional) message may be based on the incorporation of a new product (e.g., new flavor of Kellogg's® Pop Tarts®) or feature (e.g., a credit card acceptor, a new price for a product) in the vending machine. An appropriate promotional message would be one that was intended to inform recipients of the new product or feature and/or encourage purchase/use of the new product feature.

The outputting of a (promotional) message may be based on the restocking of the vending machine. An appropriate promotional message would be one that was intended to inform recipients that the vending machine has been restocked.

The outputting of a (promotional) message may be based on the location of the vending machine changing. An appropriate promotional message would be one that was intended to inform recipients of the new location of the vending machine.

The outputting of a (promotional) message may be based on a new occurrence with the vending machine that is of interest to a particular employee. An appropriate promotional message would be one that was intended to inform that employee that when the price of his favorite drink goes below a predetermined level.

The outputting of a (promotional) message may be based on a regularly scheduled time for a promotional message. For example, every Monday at 5:00 PM, the controller may send out a promotional message.

The outputting of a (promotional) message may be based on the time of day, and in particular the sales during that time of day. For example, if during certain hours of the day there are lower sales, an appropriate promotional message would be one that was intended to encourage sales during these hours (e.g., by offering a benefit, such as a discount, during these hours).

The outputting of a (promotional) message may be based on the purchase history of a particular employee. For example, The outputting of a (promotional) message to a particular employee may be based on whether the employee has (a) made more than a predetermined number of purchases at the vending machine, (b) had greater than a predetermined response rate to prior promotions, (c) agreed to receive promotional messages with at least a predetermined frequency, (d) spent more than a predetermined amount at the vending machine, (e) encouraged a predetermined number of friends to transact with the vending machine, and/or (f) met any other criteria.

An appropriate promotional message would be one that provides the employee with a benefit, even one which was so large as to result in no profit for the operator (e.g., providing the employee with a free product). However, providing the employee with the benefit may encourage the employee to remain a good customer of the vending machine. For example, the employee may wish to remain on the mailing list of the operator because of the prospect of periodically receiving offers with a large and easily apparent benefit. The employee may also share his good fortune with friends, thereby encouraging them to remain on, or to join a promotional mailing list. Furthermore, even if the operator may suffer a loss on the benefit provided, the operator ameliorate this by providing as a benefit a product that was not likely to sell before the next restocking.

The outputting of a (promotional) message may be based on the number of units remaining of a particular product (e.g., whether the number of units of a particular product exceeds a predetermined threshold). An appropriate promotional message would be one that encourages sales of the product.

The outputting of a (promotional) message may be based on the number of a units remaining of a category of products such as beverages (e.g., whether the number of a units remaining of beverage products exceeds a predetermined threshold). An appropriate promotional message would be one that encourages sales of the category of product.

The outputting of a (promotional) message may be based on the number of a units remaining of all products in the vending machine (e.g., whether the number of a units remaining of all products exceeds a predetermined threshold). An appropriate promotional message would be one that encourages sales at the vending machine.

The outputting of a (promotional) message may be based on the occurrence or imminence of a holiday or other special event (e.g., the week before Halloween). An appropriate promotional message would be one that encourages sales of, e.g., candy or whatever product is desirable to sell during the period of time in question.

The outputting of a (promotional) message may be based on product preferences of a particular employee (e.g., whether there is a discount on particular products, whether there are many units of a particular product remaining in inventory, whether new items likely to be as desirable are in stock) and/or information desired by the employee. An appropriate promotional message would be one that encourages the employee to purchase the product, or otherwise exploits the information regarding the product preference. An employee's preferences (e.g., preferred foods, beverages, or other products) may have been indicated by the employee himself using an input device of the vending machine, or using a Website of the controller. An employee may also have implied his preferences by having frequently purchased a particular product.

The outputting of a (promotional) message may be based on a change in purchasing behavior of an employee (e.g., decrease in sales volume per time attributable to that employee). An appropriate promotional message would be one that indicates the change in purchasing behavior (e.g., “Hey Bob, we noticed you haven't bought any soda this week? Is everything o.k.?”) and/or attempts to change the behavior to the previous state or to a more desirable state (“Don't forget to buy a soda today. Use the code “G4-H5-12” to get a 20% discount on your purchase.”).

The outputting of a (promotional) message may be based on the unavailability of a product (e.g., whether there are few items of a particular product remaining, whether there are few items of any product remaining). In such a situation, a decision may be made to not send a promotional message regarding that product that would otherwise have been sent. Thus, the condition (unavailability of a product) serves as an “inhibitor” which prevents or reduces the chance of sending a (particular) promotional message.

Similarly, another condition which inhibits the sending of a message is whether a maximum number of messages has already been sent (e.g., maximum for a time period).

The outputting of a (promotional) message may be based on a cost, profit margin or sales of a product (e.g., whether the cost/profit margin/sales of a product is or becomes above/below a threshold). An appropriate promotional message would be one that promotes sales of the product (e.g., products with low sales, high profit margins).

The outputting of a (promotional) message may be based on whether sales goals have been met. For example, messages can be output (possibly in increasing frequency) if sales continue to fall short of sales goals.

The outputting of a (promotional) message may be based on the ability to reach a goal, such as a sales goal. For example, messages may be sent to progressively increasing numbers of recipients until a desired sales goal is reached. Similarly, messages may be sent to the same recipients repeatedly. Successively sent messages may provide successively increasing benefits (e.g., initially a 10% discount, then 20%, then 25%) or decreasing benefits if goals are being met. Similarly, successively sent messages may be targeted to increase sales of different products, thereby increasing sales for the vending machine if, e.g., one product sells out completely.

The outputting of a (promotional) message may be based on a change in price of a product. An appropriate promotional message would be one that informs an employee of the new price of the product.

### 3.5 Transmit the Promotional Message to Recipients in Accordance with Specified Criteria

Once the promotional message has been determined/generated/selected (and also approved in various embodiments), the message may be transmitted to its intended recipients (e.g., such that it is output on a user device). Such transmission may occur in accordance with any restrictions and other desired criteria (e.g., as specified by the company). Such transmission can make use of conventional transmission protocols (e.g., email via SMTP or POP protocols).

For example, as described above, there may be restrictions on the time such messages can be sent to certain recipients, as well as on the number of such messages.

### 3.6 Perform a Transaction at the Vending Machine

In an embodiment, the vending machine may engage in one or more transactions pursuant to a promotion (e.g., a half price product, a 20% discount, a coupon redeemable for a discount on a future purchase), especially (but not exclusively) where a promotional message describes such a promotion.

In addition to the various promotions described above and in addition to those promotions known in the art, the vending machine may provide discounts at certain time periods (e.g., half price after 8:00 P.M. on weekdays). Discounts may be limited to a predetermine number of items (e.g., half price on the first ten candy bars to be sold after 8:00 P.M. on weekdays). Discounts may be paid for by, e.g., the company as a reward or incentive.

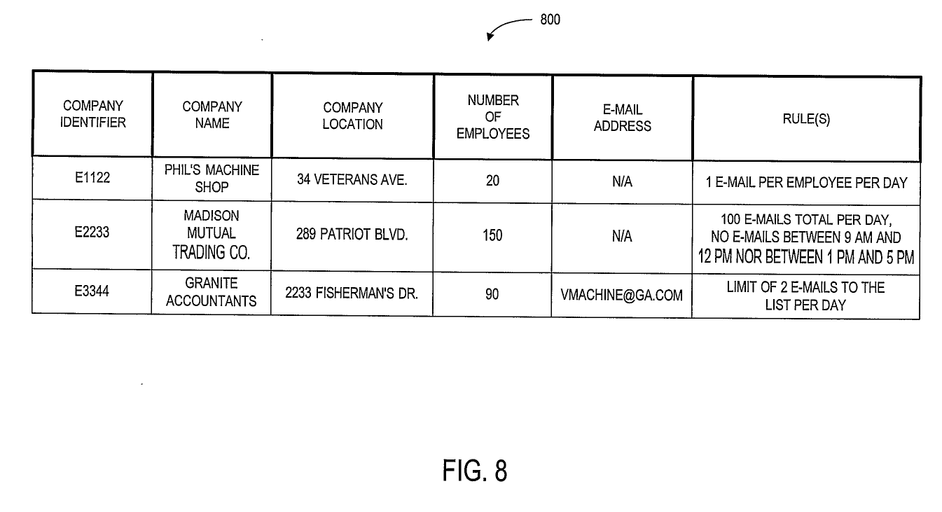

The transaction at the vending machine may include receiving a code, and providing a benefit based on the code. The code may be input to the vending machine via any of a number of input devices, such as buttons, keypads, touch screens, or remote control devices. After receiving the code, the vending machine may provide the corresponding benefit that is associated with the code. The vending machine may also update a database of codes (FIGS. 7 and 8), indicating one more uses of a code, or indicating that a code may no longer be used.

The transaction at the vending machine may also include receiving a customer identifier (e.g., customer's initials, email address, phone number, birthday, room number, credit card account number) via an input device. If the identifier is already stored by the controller/vending machine and associated with the customer, then the customer can be identified. An identified customer may pay automatically, e.g., through a credit card account or other financial account stored by the controller/vending machine.

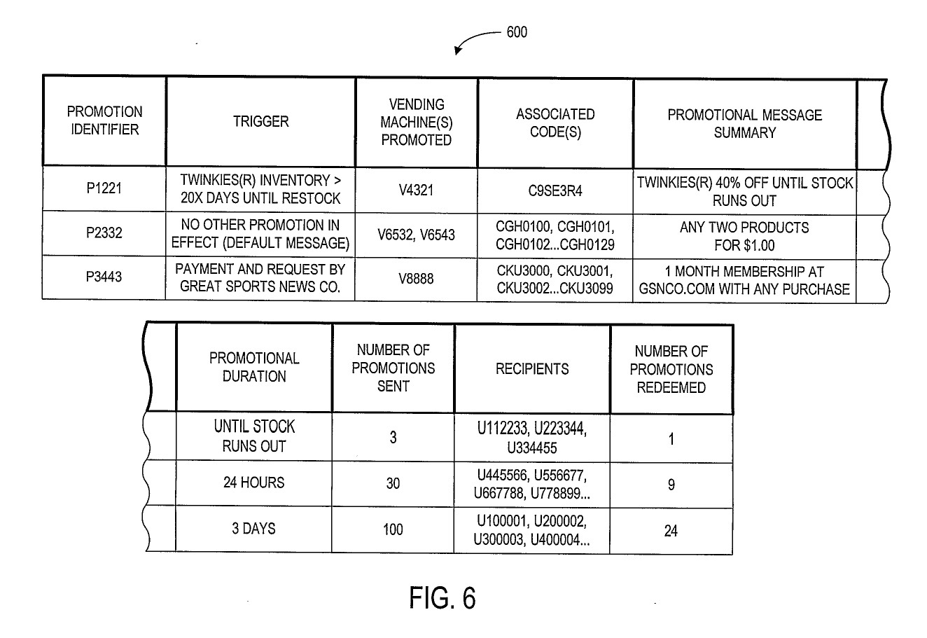

After a period of time or after a number of redemptions pursuant to a promotion (e.g., redemption of codes distributed through promotional messages), the controller may evaluate the effectiveness of the promotion. For example, the controller may determine, based on transactions performed at the vending machine(s), and based on the codes received during such transactions, the response rate of employees to a promotion (number of redemptions relative to the number of recipients of the corresponding promotional message). Similarly, effectiveness may be determined with respect to the consequential changes (if any) in sales, profitability, inventory levels, etc. The controller may record the success of various promotions using a database such as the promotional message database of FIG. 6.

The controller may employ the relative effectiveness of a promotional message to determine promotional messages to use in the future. For example, if a promotional message was deemed successful, then the controller may, for future promotional messages, use similar wording, use the promise of similar benefits, choose recipient in a similar manner (e.g., targeted to a similar demographic group, to a group consisting of a similar type of employee). Similarly, if a promotional message was deemed unsuccessful, then the controller may, for future promotional messages, use different messages.

To facilitate customized service, it can be advantageous to collect identification information (as described above) from a customer transacting with a vending machine. The customer may even be provided with a benefit for providing an identifier at the vending machine. For example, the controller may promise the customer a good promotional message to be sent to the customer later in the day if the customer enters his identifier. For instance, by entering the identifying code “1960”, the customer may later receive an email in which he is offered two products for the price of one.

The vending machine may identify a customer in a number of ways. For example, the customer may enter a code (e.g., a sequence of alphanumeric characters chosen by the customer or by the vending machine/controller) that serves as a unique identifier.

The vending machine may also identify the customer through reading a credit card or other card with readable data (e.g., electromagnetically encoded data). Such a card may be swiped through a card reader or other input device of the vending machine.

Other means of identification include facial recognition (e.g., using appropriate hardware such as a camera and recognition software), voice recognition, and biometric identification (e.g., a thumbprint reader).

An employee's email address may function as a code for receiving benefits at the vending machine, and/or as a unique identifier. The vending machine and/or controller may thus track, e.g., the number of benefits redeemed by an employee, and may also limit each employee to redeeming a particular number of benefits.

For example, the vending machine may identify the customer by sensing a “prox card”. Such cards are often used to gain access to a building with an electronically controlled lock on a door. The prox card, when placed in proximity to a reader, is detected magnetically by the reader, which in turn can trigger the lock to release, allowing access. A vending machine may detect a prox card in a manner similar to that used at doorways. The vending machine may identify a customer via an electromagnetic transmission from a customer device, such as a cell phone, watch, or personal digital assistant. The vending machine may additionally identify the customer through a fingerprint, through voice analysis, through retinal scan, or through facial recognition. The vending machine may recognize a customer passively. In other words, the vending machine may recognize a customer without the customer actively attempting to identify himself to the vending machine. Such a passive recognition system may include facial recognition, or the automatic transmission by a user device to the vending machine of an identifying signal.

Any means of identification may be used in combination, such as a biometric input and a user code which is input via a keypad.

An embodiment therefore include a method for associating a customer with an identifier, receiving the customer identifier at a vending machine, updating a customer profile for the customer based on his interaction with the vending machine, determining a promotional message based on the updated profile, and transmitting the promotional message to the customer. The method may further include offering the customer a benefit in return for his providing the customer identifier.

### 3.7 Receive an Indication That an Employee Wishes to Opt Out of the Email List

In an embodiment, an employee indicates that he does not want to receive further promotional messages. The employee may, for example, reply to a promotional message with a certain key phrase, such as “opt out” in the subject line of his email reply. The employee may also visit a Website of the controller. For example, the employee may click on a link to a Website embedded in a promotional message. At the Website of the controller, the employee may type in his email address, and the controller then removes that email address from the promotional mailing list. The command to prevent receiving promotional messages may also be entered through an input device of a vending machine.

In some embodiments, other people (e.g., a company official such as the Human Resources Director) can remove an employee's email address from a promotional email list.

In an embodiment, the controller may allow an employee to opt out from receiving promotional messages provided that a predetermined minimum number of employees still remain on a promotional mailing list. For example, if the controller requires at least fifty employees, and there are currently fifty-two on a mailing list, then the controller may allow only up to two employees to opt out of the mailing list. If less than a predetermined number of employees remain on the list, the controller may send a warning signal (e.g., a warning message in an email) to a destination (e.g., a Human Resources Director, the remaining employees, other employees).

In an embodiment, instead of a minimum number of employees being required to remain on a mailing list, if there are less than a predetermined number of employees on the list, the number of promotional messages sent to the remaining employees is increased (e.g., to make up for the diminished number of recipients). For example, the controller may be limited to sending one promotional message per day to each employee on a promotional mailing list, provided there are at least fifty employees. However, if fewer than fifty employees are to remain on the list, then the controller may be permitted to send two promotional email messages per day to the remaining employees.

The number of employees required to be on a promotional mailing list may vary dynamically in response to a number of factors (e.g., recent sales volume, profit margins, number of employees, season).

In various embodiments, rather than opting out completely, an employee may alter the frequency with which he receives promotional messages. For example, the employee may indicate that he wishes to receive messages only once per week rather than twice per week. An employee may additionally alter any other parameter for when messages are sent to him. For example, the employee may indicate a day of the week on which messages are to be sent, a time of day during which messages are to be sent, a maximum length of a message, what should be in the subject line of the message, what types of promotions should be included in the message, and so on. In various embodiments, an employee or consumer may wish to increase the frequency with which he receives messages.

### 3.8 Determine an End to a Promotion

A promotion (e.g., a reduction in prices of all products) may last for any period of time, such as a week from Saturday to Sunday, a month consisting of a particular calendar month, or a restock period consisting of e.g., a three-day period from Monday to Wednesday. A promotion period may be a period of time over which the controller or vending machine evaluates the performance of the vending machine, the period being deemed over when performance is sufficient (or is insufficient). The performance may be evaluated using such metrics as revenue, profit, number of transactions, number of customers, amount of inventory cleared, and the like. Performance may also be evaluated in terms of a number of supplementary offers accepted. For example, a vending machine may periodically offer a customer thirty free food items, to be redeemed over the course of a month, provided the customer switches his long distance phone service. The controller may evaluate the performance of the vending machine based on the number of such supplementary offers that were accepted during the promotion period.

After examining a vending machine's performance over a promotion period, the controller may determine whether goals have been met. Goals such as sales goals may include earning a predetermined amount of profit (e.g., at least $100), receiving a certain amount of revenue (e.g., at least $300), selling a predetermined number of items (e.g., three hundred items), making at least a predetermined number of transactions (e.g., at least one hundred transactions), transacting with a predetermined number of customers (e.g., with fifty customers), and the like.

### 3.9 Meeting Goals and Distributing Vending Machine Profits

In some embodiments, a fee may be collected from the company if goals (e.g., sales goals) have not been met. Such a fee may serve to, e.g., provide the company with an incentive to promote the vending machine, or otherwise attempt to have the goals met.

The amount of the fee may be determined in various ways. In some embodiments, the fee may be equal to the amount by which profits fell short of desired or agreed-upon profits. In some embodiments, the fee may be equal to some fraction of the amount by which profits fell short. The fee may also be determined as some fraction of a revenue shortfall. In various embodiments, the fee may be equal to some fixed amount for every non-monetary shortfall. For example, the fee may be determined as fifty cents for every customer less than eighty that transacted with the vending machine. Thus, if only seventy customers transacted with the vending machine, the fee would be equal to 50 cents/customer×(80 customer−70 customers)=$5. The fee may be collected by cash, check, wire transfer, or by any other means.

In some embodiments, the operator may receive other privileges if there is a shortfall. For example, if the controller was previously limited to sending out one promotional message per employee per day, the controller may increase this limit to two. In another example, if there was previously a lower limit of fifty employees on a promotional mailing list, this limit may be increased to sixty. In another example, if there was previously a restriction as to what times promotional mailings could be sent out (e.g., only during lunch hours), then these restrictions may be eased.

In some embodiments, a portion of profits from the vending machine sales may be distributed to the company.

In some embodiments, the controller may distribute a portion of profits, revenue, or other financial measurement to the company. For example, the controller may distribute any profit in excess of $300 per month to the company. As another example, the controller may distribute half of all revenue in excess of $500 per month to the company. For instance, if revenue for a month is $600, then the controller may distribute half of the amount in excess of $500 (equal to ½×($600−$500), or $50) to the company. The controller may use any other desired calculation for funds distributed to the company. For example, the controller may distribute one third of all profits in excess of $400 but less than $500, and one half of all profits in excess of $500, but in no event more than a total distribution of $200.

Such funds may be paid to the company in the form of cash, check, or other consideration. Funds may also be distributed towards the company in the form of credits toward future shortfalls. For example, if a company is due $100, the controller may withhold the $100 (e.g., in an account). If, in a succeeding month, the company owes the controller money (e.g., due to a revenue shortfall), then the controller may deduct the funds owed to it from the $100 account.

In various embodiments, funds may be distributed to the company in the form of products, or in the form or rights to free products. For example, if the controller owes the company $100, then the controller may instead provide the company with one hundred sodas, with each soda presumably valued at $1. The controller may provide the company with one hundred unique codes, each redeemable at the vending machine for a free soda. The company may then distribute the codes to its employees as it sees fit. The company may use the codes as reward mechanisms to reward employees.

In various embodiments, such as where a company may be obligated to compensate the operator, or where the operator may be obligated to compensate the company, the controller or vending machine may present the company with an audit report (e.g., of sales, transactions, and/or benefits provided at the vending machine). Such a report may be requested via the vending machine or controller (e.g., through an input device of the vending machine, through a web site of the controller). The report may then be, e.g., printed by the vending machine, transmitted via email by the controller, presented in a browser interface by the controller.

For example, the controller may provide a listing of transactions, including a time, amount paid, amount used for tax, margin, method of payment (e.g., cash, credit), product(s) vended, code received (e.g., in exchange for a free product), person to whom the code was originally given (e.g., via email), and so on. The controller may include any costs in its transaction report, such as the cost of power over the past week, or the cost of labor inherent in restocking the vending machine. The controller may aggregate the figures from various transactions to come up with a total amount of profit made for a sales period, a total amount of revenue for a sales period, and so on.

In various embodiments, if sales goals have not been met, then the operator may remove the vending machine from the company offices.

### 4. Additional Embodiments

In one embodiment, the controller may wish to obtain contact information of customers or potential customers in other ways.

For example, a vending machine may prevent access to all except those who have already provided contact information (as described herein) and/or that contact information has been validated (as described herein, e.g., by sending a message to that email address and requiring a response).

In some embodiments, when a person interacts with a vending machine, the vending machine may solicit contact information from the person. For example, the vending machine may request an email address, phone number, home mailing address, etc. The vending machine may solicit contact information by outputting a text message on a display screen, by backlighting a pre-composed message inscribed in the exterior of the vending machine, by outputting a prerecorded voice message, or through any other means. The person may then provide contact information via any number of possible input devices on the vending machine, such as a touch screen.

When soliciting contact information, the vending machine may encourage a person by describing the potential benefits of providing such information. For example, the vending machine may indicate (e.g., via a display device) that the person may be alerted when hot new products come in stock, when there are sales at the vending machine, or when there are various special deals to be had at the vending machine.

The vending machine may also offer immediate benefits to a person who provides contact information. For example, a person may receive a free or discounted product from the vending machine for providing contact information. A person may also receive a coupon or certificate good for future free or discounted products at the vending machine. A person may receive benefits with other merchants as well. For example, a person may receive a certificate from the vending machine which is good for $5 off any item at the clothing store where the vending machine happens to be located. The provision of benefits redeemable at other merchants is described in co-pending U.S. patent application Ser. No. 09/714,574, entitled “METHOD OF OUTPUTTING OFFERS AT A VENDING MACHINE FIELD”, which was filed on Nov. 16, 2000, and which is incorporated herein by reference.

When soliciting contact information from a consumer, the vending machine may provide various assurances as to how the contact information will be used. For example, the vending machine may indicate that the contact information will not be provided to any other merchants or marketers besides the owner of the vending machine. The vending machine may also assure the customer that he will receive promotional messages at no more than a certain rate, e.g., at no more than two per week. The vending machine may further assure the consumer that he may opt out from the promotional mailing list at any time, and receive no further messages.

A benefit provided by the vending machine in return for contact information may be conditioned upon the fact that the contact information is valid. Therefore, in some embodiments, a vending machine may provide any benefit to the consumer via the channel defined by the received contact information (e.g., an email channel). For example, the vending machine may email a discount coupon to the consumer at the email address provided by the consumer. The vending machine may also email a code to the consumer, wherein the code may be entered to the vending machine at a later time in return for a free product or other benefit (as described herein), subject to any other requirements as described herein (e.g., the code must first be used a minimum number of vending machine transactions). The consumer will thus be able to receive the benefit only if he has provided a valid email address that belongs to him or is otherwise accessible by him.

In various embodiments, a consumer may also supply his email address at a Website, such as at the Website of the controller. A consumer may visit the Website, type in his email address, and indicate that he wishes to receive promotions for vending machines located in a particular geographic region (e.g., in the area near the consumer's home or near the consumer's workplace). The customer may also, in the same or different interaction with the web site, indicate one or more vending machines he transacts with or desires to transact with.

In an embodiment, a consumer may transact at a vending machine that instructs the consumer to subsequently send a message, such as an email or telephone call, to the controller or to the vending machine. If the consumer later sends such a message, then the vending machine and/or controller may obtain the consumer's contact information by looking at the email address/telephone number from which the message originated. The vending machine may encourage the consumer to send a message to the controller or vending machine by promising the consumer a benefit for doing so. For example, the consumer may be promised a free product at the vending machine if he sends an email to the controller. When the user later sends such a message, the controller may reply with a code, coupon, or other indicia that is redeemable for a benefit at the vending machine.

One benefit a consumer may receive in return for providing an email address or other contact information may be a sweepstakes entry. For example, a consumer may provide an email address at a vending machine and receive a code in return. The consumer may later visit the Website of the controller and type in the code in order to be entered into a sweepstakes drawing. If the consumer wins, then the controller may email the consumer with the good news, ask for the consumer's home address, and then mail the consumer a check for the winnings. In some embodiments, the consumer need not even visit the Website. Rather, the controller may enter the consumer into a sweepstakes drawing directly based on the consumer having provided his email address at the vending machine. The controller may later inform the consumer (e.g., via email) of whether or not the consumer has won.

In an embodiment, employees of a company (or other potential consumers) may provide the controller with parameters for sending promotional information to them. For example, an employee may visit the Website of the controller. At the Website, the employee may answer a question “Inform me when . . . ” after which are listed several check boxes labeled, “1) Items go on sale; 2) New items are introduced; 3) Items run out of stock; 4) Caramel Popcorn is restocked; . . . ” The controller may then send promotional emails to the employee based on the preferences the employee filled out and based on the status of the employee's local vending machine. In some embodiments, a consumer may provide parameters or preferences while he is at a vending machine using, e.g., keypads or touch screen input devices.

Any of the aforementioned rules, criteria, and limitations for sending emails to the employees of a company might vary from employee to employee. For instance, the times at which a controller may send emails to employees may be different for night-shift and for day-shift employees. As another example, the controller may be allowed to send only one promotional email per week to any company vice-president, but up to three per week to lower-level employees.

In an embodiment, the controller may be given special privileges or techniques to bypass company spam filters. For instance, Information Technology specialists at the company may work with the controller on the format of the controller's emails so that the emails will be able to bypass company filters. Information Technology Specialists, or other company employees, may also set the company spam filters to allow the passage of messages from the controller (as indicated by return email address, subject line, etc.). Another way for promotional messages to bypass company spam filters may be for the vending machine to possess its own address or account on a company intranet.

The controller or vending machine may periodically verify that company employees have actually received promotional messages. One method of verification may involve offering a particularly desirable benefit through a promotional email. If the benefit is not redeemed, then the controller may assume that a company employee is not receiving promotional emails. For example, the controller might offer a company employee two free products at the vending machine, provided he enters a code from an email. Presumably, such a benefit would be too good to ignore, unless a company employee was not seeing the promotional emails. Using another method, a vending machine may inquire during a transaction about information contained in a prior promotional message. For example, a vending machine may output three graphics on its display screen, and ask the customer to select the one that appeared in the last promotional email. If customers consistently answer incorrectly, then the vending machine may assume its promotional messages are not being read. Using still another method, the controller may check for changes in sales patterns following the dissemination of a promotional message. If no such changes occur, then the controller may infer that the promotional message has not been seen by company employees, for example.

In various embodiments, a vending machine need not be in direct communication with the controller or even be connected to a communications network. In such embodiments, a vending machine may receive information from the controller (or from another device/entity) via a route operator. For example, a route operator may insert a disk into the vending machine, where the disk contains messages for the vending machine from the controller. Messages may indicate for example, what promotional codes are valid, how many times they may be used, what benefits the vending machine is to provide upon receiving the promotional codes, and so on. The vending machine may then record the use of promotional codes. Later, the vending machine may indicate via the route operator which codes were used, how often they were used, and so on. The vending machine may also report other information via the route operator, such as the total amount of sales for a given sales period, the particular products remaining in inventory, etc.

Other information that may be transmitted to the vending machine via the route operator may include what promotions to offer. For example, the controller may indicate to the vending machine that it should offer 50% off on all cupcakes until they sell out.

The controller may account for possible delays in its transmission of information to a vending machine by timing promotions to occur in the future. For example, suppose the controller wishes to offer a two-for-one package deal, where a consumer may buy any two items from the vending machine for $1. However, the route operator will not visit the vending machine for another three days. Therefore, the controller may transmit a promotional message to company employees indicating that there will be a two-for-one package deal at the vending machine in three days (as soon as the route operator can get the message to the vending machine).

In one embodiment, the vending machine controller may instruct a company employee as to how to enable promotions at a vending machine. For example, the controller may instruct the HR Director at a company to enter the code, “9321x2q2z” into the vending machine. The vending machine may contain a database of codes and interpretations, and may therefore be able to interpret the aforementioned code as “offer a 20% discount on all carbonated drinks for the next three days.” The vending machine may then implement a promotion without the need to wait for a route operator. The code entered by the HR Director may be valid only once, preventing the HR Director from re-starting the promotion at a later point at his own initiative.

In an embodiment, a promotional message may be directed to a subset of company employees, such as a single company employee, who is charged with encouraging other company employees to transact with the vending machine at the company. For example, the controller may send a message that reads, “Hey Bob! We need to squeeze $80 more in sales from the vending machine in the next three days. See what you can do.” Bob may then promote the vending machine at his company in any way he sees fit. He may send an email to other company employees, he may post signs in the company offices, or he may talk to the company employees to encourage them to transact with the vending machine. For their efforts, the company employees charged with promoting the vending machine may receive special benefits, such as free or discounted products, package deals, or a portion of vending machine profits. In some cases, the company employees charged with promoting the vending machine may be company officials or may otherwise represent the company. Part of the benefits for promoting the vending machine may go to the company as a whole. For instance, a portion of profits from the vending machine may go towards the company holiday party.

In one embodiment, the vending machine, controller, a company representative, or other party, may declare a day or a time period to be a “vending drive.” Similar to a blood drive, a vending drive may be a time when people are encouraged to make purchases from the vending machine. Progress towards revenue goals may be tracked. Such progress may be displayed at the vending machine and via promotional emails. Similarly the onset of the vending drive may be declared via displays at the vending machine and via promotional emails. A portion of proceeds from a vending drive may, in some embodiments, go towards a charitable cause.

In one embodiment, promotional messages may be physically attached to vended items. For example, a package of potato chips may have a promotional message stapled to it. When a person then buys the potato chips, the person may read and act upon the promotional message. Promotional messages may be attached to vended products by the route operator who fills the vending machines. In various embodiments, promotional messages may be printed on stickers. Thus, the promotional messages may be affixed to products by pressing the adhesive sides of the stickers to the products.

5. Payment

In various embodiments, an employee or other customer need not pay immediately for a vended product. Rather, the employee may be identified by the vending machine, and a charge for the product may be posted to an account of the employee. The account may be a conventional credit account, where, e.g., the employee owes the controller for purchases. Alternatively, the account may be backed by previously tendered funds, in which case an amount of a purchase may be deducted from such funds. Alternatively, a company official may be provided with a list of employees who owe money to the vending machine, and the company official may then collect from the employees. In another exemplary embodiment, amounts owed to the vending machine may be deducted from employees' paychecks.

If an account is a credit account, then the employee may be responsible for compensating the controller after predetermined periods of time. For example, at the end of every week, an employee may be responsible for paying the vending machine for purchases he made on credit during the prior week.

The employee may compensate the controller by inserting currency into the vending machine. The employee may also visit a Website of the controller and provide a credit card number. The employee may then authorize the controller to charge his credit card for the amount owed the vending machine. The employee may also insert a credit, debit, or other card into the vending machine. The vending machine may then process a financial transaction in standard fashion known in the art, thereby receiving funds from a financial account of the employee as compensation for items purchased on credit. The employee may further insert a check into the vending machine, the check made out for sufficient funds to cover the week's purchases.

One benefit of allowing a person to pay an aggregate total for purchases at a vending machine is that a number of credit card transactions may be reduced. For example, rather than a person separately charging his credit card for five different candy bars purchased over the course of a week, the person may charge his credit card once for the aggregate cost. The person may thereby avoid the inconvenience of taking out and swiping his credit card on every transaction. The controller may, in turn, avoid credit card fees for multiple, small transactions. Such fees may compromise a large percentage of small transactions.

There are a number of other ways in which an employee may compensate the controller for purchases made on credit. An employee may perform work. For example, an employee may answer product survey questions at the vending machine using a touch screen to input his answers. Customer participation in surveys at a vending machine is more fully described in U.S. Pat. No. 6,161,059, entitled “Vending machine method and apparatus for encouraging participation in a marketing effort”, which was issued on Dec. 12, 2000, and which is incorporated herein by reference.

An employee may also accept a marketing offer. For example, the employee may agree to switch long-distance phone services, in return for which his debt may be waived. An employee may further provide names and or contact information for other people. The controller may then have the opportunity to market to these other people by transmitting a promotional message to the supplied email address, for example. In another embodiment, the amount of employee purchases may be deducted from the employee's paycheck. In another embodiment, an unpaid amount may be deducted from, or charged to a departmental or company account. For example, if an employee does not pay a $5.00 credit owed by him, then the $5.00 charge may be posted to a company account. The company may then be responsible for paying the $5.00. The company may, in turn, seek compensation from the employee. In further embodiments, an employee may pay using a PayPal™ and/or various forms of electronic currency transfer.

In various embodiments, an employee with an outstanding charge to his account may be charged interest. For example, the vending machine may have a prevailing interest rate of 5% per year, compounded weekly. Therefore, an employee may owe more and more interest for every week in which he does not pay an outstanding balance.

To purchase an item on credit, an employee may enter one or more identifiers (e.g., via an input device at the vending machine during a transaction). He may enter a name, phone number (e.g., office extension), birthday, room number, email address, title (e.g., “VP Marketing”), code, or other identifier, including a random identifier. The employee may also purchase on credit using a non-employee-specific account. For example, an employee may make a purchase using an account of the legal department or of the finance department. If the employee is charging a purchase to a non-employee specific account, the employee may be required to enter some authorization code, or some other identifier that proves he has the authority to charge such an account. For example, the employee may enter an identifier proving that he has at least a director level title. Such an identifier may be, for example, a title or a code that has been given out only to employees with director level titles or above. One exemplary use of a non-employee-specific account may be the purchase of multiple items for a meeting. For example, the head of sales may use an account for the sales department to purchase a number of sodas for a meeting.

An employee may identify himself in a number of other ways in order to gain access to an account. An employee may use an electronic access card. For example, a vending machine may be configured to recognize the same access cards that are used by the company offices. The vending machine may be further configured to recognize individual employees from their access cards. An employee may also identify himself through biometric information, such as fingerprints, voiceprints, retinal scans, facial scans, and so on.

In various embodiments, a person may fund an account in advance. For example, an employee may insert a $20 bill into the vending machine without receiving any change. The employee may then draw upon the $20 in making further purchases, with each additional purchase deducting from the $20. The controller may benefit from this advanced funding behavior, because people with funded accounts may be more likely to make purchases. Thus, the controller may provide a person with a funding bonus. For example, the controller may provide an employee with a 20% bonus such that, for example, funding an account with $20 may result in an account balance of $24. When an employee funds an account, the employee may determine a password that will allow him access to the funds in the future.

In various embodiments, a first employee may fund an account of a second employee. For example, a first employee may insert $5 into a vending machine, key in an identifier for the second employee (e.g., the second employee's name), and indicate that the $5 is to be added to the second employee's account. Alternatively, the $5 may be used to pay off a debt accumulated by the second employee. When a first employee funds the account of a second, the funding may be considered a gift. For instance, a first employee may provide a second with a $5 gift credit at a vending machine in return for the second employee's having covered the first at a meeting. The first employee may even key in a message for the second employee when he indicates a desire to provide funds for the second. An exemplary message might read, “Hey, you did a great job on that project last week. Use this to buy yourself a few cold drinks.—Bob.” When the second employee later keys in an identifier to make a purchase using his account, the message from the first may appear. In any event, a message may appear from the vending machine indicating that another person has provided the second employee with a gift of $5. In various embodiments, the gift may be anonymous, and so the second employee may not know the identity of the first employee. As with self-funding events, gifting events may result in bonus funds being awarded. For example, when a first employee gives a second employee a gift of $5, the second employee may have $6 added to his account, the extra dollar courtesy of the controller.

In various embodiments, an employee may purchase a gift certificate on credit. For example, an employee may insert $10 into the vending machine. The vending machine may then print out a gift certificate for $10. The employee may then give the gift certificate to another person. The other person may then purchase vending items by inserting the gift certificate into the vending machine, or by entering a code on the gift certificate into the vending machine. Of course, a person need not buy a gift certificate on credit. Additionally, a vending machine may add a bonus amount to a gift certificate. For example, a person may purchase an $11 gift certificate for $10.

For embodiments in which people may make purchases on credit, honest behavior may be more likely when people are making purchases at a vending machine within their own company. By acting dishonestly, e.g., by making purchases on credit without intending to repay the credit extension, or by attempting to use someone else's account without permission, a person might jeopardize his standing at a company. Therefore, embodiments in which a person may make purchases on credit, or where a person may fund an account in advance, are particularly well suited to situations where a vending machine is internal to a company. Furthermore, fraud may be avoided if a company official has the ability to access or track account records. For example, if the Human Resources director can see that a given employee has a large unpaid debt to the vending machine, the person may be more likely to repay the debt.

### 6. Employee Accounts

The status of an employee's account may be sent to him periodically by the controller. A status may include recent purchases made, amounts owed, or funds available for future purchases. The status report may include amounts of accrued interest, bonus amounts added to the account, or gifts added to the account. The status report may include warnings about suspension of privileges. For example, a user will not be allowed to make further purchases on credit unless he pays off prior purchases. The status report may indicate a manner in which the employee may pay off prior purchases, such as e.g., visiting a Website of the controller and entering a credit card number, or inserting currency at the vending machine. The status report may also include a message that a password or other account access code is expiring and/or should be changed within a certain time period.

Employee accounts may be set up by employees themselves. For example, a person may set up an account by visiting the Website of the central controller and by typing in an identifier (such as a name) and an access code or password. The identifier and password may later be keyed into the vending machine in order to access the account. For example, the identifier and password may later be keyed in to allow the employee to make purchases on credit, or to make a deposit to his account. Alternatively, an identifier or password alone may be sufficient for accessing an account. At the Website of the central controller, the employee may also provide a financial account identifier or other means to fund his account. The employee may or may not authorize automatic deductions from the financial account for purchases made on credit. In various embodiments, an employee may also set up an account at a vending machine. Here too, the employee may choose an identifier and password, and may enter financial account information.

In various embodiments, a person's account with the controller may be set up automatically by the controller due, e.g., to the person's status as an employee of a company in which the controller has placed a vending machine. For example, when the controller first agrees to place a vending machine in a company, the controller may obtain a list of the company employee email addresses. The controller may then set up accounts automatically with the email addresses serving as identifiers or access codes to the account. An employee may subsequently purchase an item from the vending machine on credit by simply entering his email address at the vending machine. In some embodiments, a company may provide guidance to the controller over which accounts should be set up automatically. For example, the controller may indicate that accounts should be set up automatically only for employees with more than one year of work experience at the company. Other third parties besides an employer may likewise direct the establishment of an account for another.

In some embodiments, an employee account may be set up automatically, but the employee may still be required to activate the account. Activating an account may include agreeing to certain terms or conditions. Agreeing may include agreeing to pay the balance of an account periodically, agreeing not to share passwords or account identifiers, agreeing not to use other people's accounts, and so on. Activating an account may also include determining an identifier and access code or password.

In various embodiments, when an employee first activates or first uses an account, the controller may automatically add funds to the employee's account. For example, the controller may automatically put $3.00 into a person's account when he activates it. In this way, the person may make $3.00 worth of purchases, without having to insert any money, and without owing anything. This may acclimate a person to making purchases without depositing money.

In various embodiments, the controller or vending machine may enable users to have accounts by tracking one or more of: (i) a user financial account identifier, such as a credit card or debit card number; (ii) a credit limit for user (i.e., a limit on a total amount of purchases a user can make at a vending machine without paying immediately); and (iii) an amount currently owed by a user based on previous purchases made on credit. The controller may track the aforementioned information in a database such as the user database of FIG. 6. For example, tracking a user financial account identifier may allow the controller to bill the financial account for the total price of purchases made on credit by the user during a given time period. Additionally, the controller may track a user identifier, password, and/or access code; an interest rate that is to be applied to unpaid balances; a schedule of times when a user is obligated to repay outstanding balances; a minimum payment amount or percent that indicates, for example, the minimum amount of an outstanding credit balance that a user must repay at a given time; contact information for an official at the user's company or for some other party that may be able to influence the user to repay outstanding balances; and so on.

### 7. Company Groups

In an embodiment, a controller or vending machine may treat the recipients of messages as two or more different groups of people. For example, the controller may send different promotional messages to the accounting department of a company than are sent to the legal department of the company. The controller may use this distinction between groups of people to promote some friendly competition. For instance, the controller may encourage the accounting department to buy more at the vending machine than does the legal department. At the same time, the controller may encourage the legal department to buy more than does the accounting department. At the end of a designated period, such as at the end of a month, the controller may provide a benefit to the group that has collectively made the most purchases. For example, if the accounting department bought one hundred beverages as a whole, and the legal department bought eighty beverages as a whole, then each person in the accounting department may be rewarded with a free beverage at the vending machine. Other exemplary groups of people might be managers, non-managers, men, women, new employees, senior employees, employees of a first company, employees of a second company, people with names beginning with “A” through “M”, and so on. In addition to increasing the sales at a vending machine, the group competition may lead to more cohesion in general among groups of people at a company.

The controller may also single out various groups as a way to make the group members feel important. For example, the controller may send a promotional message to the accounting group indicating that there is a two-for-one package deal going on today, just for accountants. The controller may provide a unique code in each message to a member of the accounting department, so that only members of that department may obtain the package deal. The employees of the accounting department, upon receiving such a promotional message, may feel especially privileged and may therefore be more likely to obtain the two-for-one package deal.

In various embodiments, two or more groups may attempt to promote sales at the vending machine. Each group may have an associated code. Whenever a code is inputted into a vending machine during a transaction, the corresponding group may get credit for the transaction. Thus, members of a group may recruit friends and coworkers and others to make purchases at the vending machine, and to use the group's code, in order that the group may get credit for the transaction. At the end of a designated period, the group associated with the most number of transactions may win a prize. The promotion of vending machines by non-owners is described in U.S. patent application Ser. No. 09/688,372, entitled “Method and apparatus for facilitating promotion of sales at a vending” which was filed on Oct. 10, 2000, and which is incorporated herein by reference.

### 8. Charities

The controller may, in various embodiments, provide money or other benefits to a charity or other organization. The controller may base the donations on sales at a vending machine. For example, the controller may donate 5% of all profits at a vending machine to a charity. As another example, the vending machine may donate 40% of revenue received from the sale of a particular item, such as Arctic Ice Cream Bars. As a third example, the vending machine may donate 20% of all revenue received at a vending machine during a certain promotional period, such as during the two hours before a restocking event.

The controller or vending machine may emphasize in promotional messages that a portion of sales at the vending machine will benefit charity. For example, a promotional message may say, “If you buy something from the vending machine by the elevator in the next hour, ten cents will go to supporting the Special Olympics.” Knowing that their purchases are contributing to a worthy cause, people may be encouraged to make purchases at vending machines.

In various embodiments, charitable donations from revenue at a vending machine may be based only on purchases in which a customer submits a code. For example, the controller may send a promotional message that includes a code to be entered by customers who wish a portion of their purchases to go to charity. A user who receives such a message may visit a vending machine, make a purchase, and enter the corresponding code. The controller may then donate a portion of the purchase price paid by the customer to charity. In some embodiments, there may be multiple possible codes for a customer to enter. Each code may correspond to a different charity. The customer may indicate a desired charity to receive the donation based on the code he enters.

In various embodiments, employees at a company may come to a joint agreement as to the charity to which a vending machine will donate. For example, employees at the company may vote on the charity. Each employee may indicate a desired charity by, for example, replying to a promotional message with a particular charity indicated (e.g., written in the subject line of the reply), by visiting the Website of the controller and selecting a charity, by indicating a charity at the vending machine (e.g., by entering the name of a charity with a touch screen keypad), or in some other manner. In some embodiments, an employee's sway in the selection of a charity will depend on his purchase history at the vending machine. For example, an employee may be entitled to one vote for every dollar he has spent at the vending machine in the past week.

The ability of employees or other customers of a vending machine to participate in the selection of a charity may make them more actively interested in the vending machine, and therefore more likely to make purchases. In addition, the employees are more likely to care about the charity that is ultimately selected, and may therefore be more likely to make purchases that will benefit the charity.

### 9. Vending Machine Messages

In various embodiments, a vending machine may print out a promotional message consisting of a game piece or game entry. For example, a user may collect such game pieces and try to obtain a complete set of a particular type of game piece (e.g., a complete color group in a Monopoly®-themed game).

In various embodiments, a vending machine may print out a promotional message for any customer that walks by, even if the customer does not engage in a transaction at the vending machine. The vending machine may, for example, have a promotional message perpetually dangling from a message printer. If the message is taken by a passer-by, the vending machine may print out a new message to dangle for the next passer-by.

In various embodiments, a vending machine may produce printed promotional messages after every transaction at a vending machine, so that customers become accustomed to receiving such promotional messages from the vending machines.

### 10. Referrals

In various embodiments, a first consumer may derive benefit at a vending machine from encouraging a second consumer (e.g., a friend) to make a purchase at a vending machine. When a person transacts at a vending machine, the person may have the opportunity to indicate the person who encouraged him to visit the vending machine. For example, when Bob makes a purchase at a vending machine, Bob may key in the email address for Linda Brown, lbrown@sunrise.com, in order to give Linda credit for referring him.

One person may indicate another in various ways. The referring party may be indicated by his or her name, email address, phone number, pseudonym or handle, or by an identifying code. An identifying code may be provided to e.g., an established customer of the vending machine. Such an identifying code may uniquely identify the customer. The customer's friend may then indicate the customer as a referring party by keying in the customer's identifying code when making a purchase from the vending machine.

A referring customer may benefit in a number of ways. The referring customer may receive free or discounted products, two-for-one specials, special notices about the presence of new products, entries into sweepstakes drawings, and so on. The referring customer may receive a benefit whose magnitude is related to the number of customers he refers, to the number of customers referred by the customers he refers (ad infinitum), to the amount of purchases made by customers he refers, etc. For example, a customer may receive twenty cents off the purchase price of an item for every customer he refers.

A promotional message sent to a customer may therefore pertain to the customer's referral history. For example, a promotional message may thank a customer for the five people he has referred in the past week. The promotional message may further indicate a benefit to which a customer is entitled based on the referrals he has made. A promotional message, such as a message to a new customer, may indicate that the person referring the new customer has been given adequate credit. For example, a message may say, “Thanks for trying the HealthNut vending machine. We have given your friend Linda credit for referring you.”

### 11. Progressive Benefits

In various embodiments, a consumer may build towards a benefit through a series of transactions. For example, a consumer's eleventh item at a vending machine may be free. Thus, through ten purchases, a consumer is building towards earning a free eleventh item. Exemplary benefits include free or discounted products, two-for-one deals, free downloads from the vending machine, and so on.

A consumer's purchases may be tracked by the controller or vending machine. For example, each time the consumer makes a purchase, he provides an identifier, allowing the vending machine to add one to a tally of his purchases. A consumer's purchases may also be tracked on a card the consumer may carry with him. For example, the consumer may carry a plastic card, which he inserts into the vending machine during each transaction. The vending machine may alter the information stored on a magnetic stripe of the card to indicate that the customer has completed another purchase. As will be appreciated, the vending machine may also alter the card by making a physical marking, such as punching a hole in the card, placing a stamp on the card, or nicking the edge of the card. The card may also include a smart card, in which case the vending machine may download updated information into the memory of the card with each purchase.

A consumer who is “building” towards a benefit may be motivated to continue returning to a vending machine, at least until he has received the benefit. Further, the consumer will be motivated to make a purchase at a particular vending machine, the one providing him with a benefit, rather than at any other.

Promotional messages may accordingly include information about a consumer's progress towards earning a benefit. For example, a promotional message may say, “Jane, great news! You need to make only three more purchases at the elevator vending machine before you can take a free Coke®!” In addition, promotional messages may advertise the fact that a person can work towards earning a benefit at a vending machine.

### 12. Identifying a Company/Location

According to one embodiment, a company is identified/selected as having a potentially profitable location for one or more vending machines.

A company (e.g., a law firm, accounting firm, manufacturing company, consulting firm, doctor partnership, government agency, nonprofit organization, school, university) may include a division of a company, a subsidiary of a company, a spin-off of a company, and the like. In various embodiments, a company may include any group of people who perform at least some work for a common organization, or who work in the same locale, facility, or complex. In addition, a company may include a group of companies.

In an embodiment, the company may possess an “office” where one or more employees of the company reside at one time or another. An office includes space in a building, a factory floor, a worksite, such as a mine, a farm, a construction site, a forest where trees are harvested, a distribution center, an airport, or any other physical locale where work is performed.

In various embodiments, an operator may identify a company according to one or more criteria (e.g., criteria reflecting the potential profitability of a vending machine placed with the company). The operator may identify/select potential companies manually, and or utilizing any of a number of known computer-based demographic targeting systems. The criteria may include one or more of:
a) The number of employees is within a desired range
b) The average number of customers who visit the company offices per day is within a desired range
c) The number of employees with access to email at work is within a desired range
d) The number of employees at a particular office (e.g., the company's headquarters) of the company is within a desired range.
e) The size (e.g., by the number of square feet) of a particular office of the company is within a particular range.
f) The typical working hours of employees at the company span a certain range (e.g., typically work late, typically work more than ten hours per day).
g) Whether one or more sources of food (e.g., cafeteria, restaurants, vending machines) are already available (e.g., in or near the offices of the company).
h) Whether there are certain types of food sources (e.g., snack food vending machines, beverage vending machines) available.
i) Whether one or more sources of water (e.g., water fountains, water coolers) or other drink are available.
j) Whether certain types of work performed, such as intense physical labor or exclusively computer-based data entry.
k) Whether the average temperature/peak temperature at the company is within a certain range.
l) Whether the average humidity/peak humidity at the company is within a certain range.
m) Whether company offices are used by other organizations (e.g., a Boy Scout troop).
n) The location of the company, such as whether a vending machine placed at a company would be easier to stock and service.

Such criteria, as well as others, can indicate the types of vending machine that may be most successful. For example, if there are not many food sources available at or near a company, then a snack vending machine may be expected to be particularly profitable at the company. If company employees perform intense manual labor, then it may be expected that the employees would frequently become thirsty, and would therefore be likely to buy beverages from a vending machine. If many company employees have email access, then sales at a vending machine may be increased by sending email promotions to the employees, as is described herein.

Various embodiments may include receiving information about one or more companies before a company is determined or chosen. The controller may receive information from a number of sources. Sources may include company filings, such as annual reports. Sources may include company Websites. Sources may include directory listings, such as listings in a phone book. Sources may include company employees. For example, a representative of the controller may contact a company employee by phone and ask for information about the company.

In some embodiments, the company may submit information via a Website of the operator. For example, the company may request a vending machine from the operator. Accordingly, a company representative may visit the Website of the operator and may provide any information required by the operator in order for the company to be considered as a potential recipient of a vending machine. The company representative may provide such information as the company location, the desired type of vending machine (e.g., snack, beverage), the number of employees, and any other information that may be useful for the operator in deciding whether to place a vending machine with the company. The Website may contain forms with fields into which the representative is to enter information about the company. Certain fields may contain required information (e.g., information about whether or not the company wants a vending machine) and other fields may contain optional information (e.g., the demographic breakdown of company employees). The Website may additionally or alternatively include check boxes, menus, radio buttons, or other input mechanisms.

In some embodiments, prior to a company representative visiting a Website of the operator, the operator may actively market to companies. For example, the operator may send a brochure to a company advertising the benefits of having a company vending machine. The brochure may direct a company representative to the Website of the operator. The controller may also market by sending email messages or by sending a salesperson to visit the company.

The operator may maintain a database of companies and associated company information. An example of such a database is shown in FIG. 9. If or when the operator has an opportunity to place a new vending machine (e.g., the operator has constructed or received a new vending machine), the operator may access its database of companies, determine which company is likely to generate the most profits for the operator, and decide to place the vending machine in the determined company. Many other criteria for selecting a company may also be employed by the operator.

In some embodiments, a company representative may identify one or more people relevant to the interaction between the operator and the company. For example, the company representative may indicate the identity of:
a. A company employee who will screen promotions sent by the operator
b. A company employee who will be responsible for paying the operator for the use of the vending machine, for a revenue shortfall of the vending machine, or for any other reason
c. A company employee who will encourage the use of the vending machine within the company
d. A company employee who will be responsible for displaying company bulletins on the vending machine
e. A company employee who will lead a group whose goal it is to make a minimum number of purchases from the vending machine
f. A company employee who will provide the operator with contact information for other company employees
g. A company employee who will fill or restock the vending machine
h. A company employee who will perform maintenance on the vending machine
i. A company employee who will contact the operator to make requests for new products, for maintenance to be performed, for the vending machine to be moved, or for various other tasks to be accomplished
   The operator may later interact, as appropriate, with the people identified by the company representative. For example, the operator may later forward promotional emails to the employee designated to screen the emails.

In some embodiments, once a company representative has been in communication with the operator, such as via the operator's Website, the operator may generate an agreement or contract describing a potential relationship between the company and the operator. The agreement may be generated based on information provided to the operator by the company representative. For example, the company representative may indicate a number of employees at the company. The operator may then apply a formula to derive an expected amount of revenue to be made from placing a vending machine at the company. For example, based on the company having fifty employees, the operator may determine that a vending machine placed at the company would be expected to make $90 per week in revenue. The operator may require, however, that a vending machine receive at least $100 per week in revenue. Therefore, the operator may determine as part of the contract that the company must pay the operator $10 per week in order to have the vending machine stationed at the company. Alternatively, the operator may determine as part of the contract that the company must pay the operator the difference between $100 and the actual amount of revenue received, and need not pay anything if revenue exceeds $100.

A contract generated by the operator may be displayed on the operator's Website. The company representative may have the ability to view and to sign the contract on the Website. For example, supplying a signature may consist of supplying the initials of the company representative or of supplying an electronic signature. Alternatively, the company representative may print out the contract, sign it physically, and mail it in to an address of the operator. In some embodiments, the company representative may enter in an account number for the company. The account number may be a credit card account number. The company representative may authorize the operator to deduct funds from the company account in accordance with the contract between the company and the operator.

In various embodiments, the operator may determine a location rather than a particular company. The location may be determined based on its proximity to one or more companies. The location may also be determined based on any of the other factors described above. If the location determined by the operator happens to be owned or controlled by a particular company, then the operator may negotiate with the company for the placement of a vending machine at the location.

To supply machines to one or more buildings of an office park, or to every building of an office park, the operator may negotiate with a property manager or property owner for the office park.

### 13. Placing a Vending Machine in Proximity to the Company Offices

An appropriate vending machine may already be located in a desired proximity to the company offices. The operator may place a vending machine in proximity to the company offices, or retrofit an existing vending machine located in proximity to the company offices. Exemplary locations for the vending machine may include:
a. A lobby of the company offices
b. A kitchen or cafeteria of the company offices
c. Near an entrance or exit of the company offices
d. Near an elevator shaft of the company offices
e. A main hallway or corridor of the company offices
f. Across the street from the company offices
g. In the building in which the company offices are located

In various embodiments, the vending machine may be co-branded with the company. For example, if the vending machine is of a type that serves “Susan's Snacks” and the company is “Vanadium Enterprises,” then the vending machine may carry the two brands together, e.g., “Susan's Snacks and Vanadium Enterprises.” Employees of the company may be more trusting of a vending machine that has the company branding on it. For example, employees may trust that personal information will not be abused. Employees may also trust that they will not receive unsolicited marketing messages if they provide their email addresses or other contact information.

When a vending machine is co-branded with the company in which it resides, the vending machine facade may contain color schemes, patterns, signage, and other markings that are hallmarks of the company. For example, if the company at which the vending machine resides has a white and purple logo, then the vending machine facade may also be colored in white and purple. The vending machine may thereby fit in with general décor of the company. The vending machine may therefore be more acceptable, and not viewed as out of place in e.g., an elegant setting. Of course, a vending machine's facade may also be made to match the colors of surrounding walls or furniture (e.g., a wood-grain surface), even if these colors are not those associated with the company in the public's mind. Such a consistency would again serve to make the vending machine less obtrusive.

A further advantage of co-branding a vending machine with the company's logo is that the vending machine may be understood to play a role in the company's function. For example, a vending machine may post messages for company employees on a display screen. For instance, “remember to get your flu shots today.”

A further advantage of a co-branded vending machine is that employees may be less inclined to try to cheat the vending machine. For instance, if an employee purchases a product on credit, the employee may feel as if he owes money to his company rather than to some unknown vending operator. The person may thereby feel a greater obligation to repay the debt.

A further advantage of co-branded vending machine is that employees may be less inclined to abuse the vending machine by, for example, banging on the vending machine when a product does not immediately fall out.

We claim:

1. A method comprising:
providing an offer, via an interface at a vending machine, for a benefit in exchange for an email address;
receiving, via the interface at the vending machine, an email address; and
after receiving the email address, transmitting a promotional message to the received email address, in which the promotional message includes
a code that is redeemable for a benefit at the vending machine.

2. The method of claim 1, in which receiving, via an interface at a vending machine, an email address comprises:
receiving a plurality of email addresses via the interface at the vending machine.

3. The method of claim 1, further comprising:
validating the received email addresses.

4. A method comprising:
providing an offer, via an interface at a vending machine, for a benefit in exchange for an email address;
receiving, via the interface at the vending machine, an email address; and
after receiving the email address, transmitting a promotional message to the received email address, in which the promotional message includes
a message promoting the vending machine.

5. The method of claim 4, in which receiving, via an interface at a vending machine, an email address comprises:
receiving a plurality of email addresses via the interface at the vending machine.

6. The method of claim 4, further comprising:
validating the received email addresses.

7. A method comprising:
receiving a set of email addresses;
identifying at least one vending machine to be associated with the set of email addresses;
determining at least one rule defining restrictions on when a message may be sent to at least one of the email addresses; and
sending a message via email transmission to each of the set of email addresses in compliance with the restrictions on when a message may be sent,
in which the message includes content that promotes the vending machine.

8. The method of claim 7, in which sending a message via email transmission to each of the set of email addresses comprises:
sending the message to a predetermined address;
determining whether approval has been received; and
sending a message via email transmission to each of the set of email addresses only if approval has been received.

9. The method of claim 7, further comprising:
receiving data representing a preference of a customer;
determining an email address from the set of email addresses that corresponds to the customer;
determining a second message according to the preference; and
sending the second message via email transmission the email address that corresponds to the customer.

10. The method of claim 7, further comprising:
generating a promotion for the vending machine; and
in which the step of sending a message comprises:
accessing a database of consumer preferences;
determining, from the database, a set of recipients that have preferences corresponding to the promotion; and
determining a respective email address for each of the set of recipients; and
sending a message via email transmission to each of the respective email addresses, in which the message indicates the promotion.

11. The method of claim 10, in which generating a promotion for the vending machine comprises:
generating a promotion for the vending machine based on at least one revenue management factor.
